(19) United States
(12) Patent Application Publication
(10) Pub. No.: US 2019/0188813 A1
(43) Pub. Date: Jun. 20, 2019

(54) HEALTHCARE ACCOUNTABILITY AND SUPPORT PLATFORM

(71) Applicant: Rosemarie D. Maljanian, Farmington, CT (US)

(72) Inventor: Rosemarie D. Maljanian, Farmington, CT (US)

(21) Appl. No.: 16/160,143

(22) Filed: Oct. 15, 2018

Related U.S. Application Data
(63) Continuation of application No. 14/143,642, filed on Dec. 30, 2013, now abandoned.
Application No. 14/143,642 is a continuation-in-part of application No. 14/072,451, filed on Nov. 5, 2013, now abandoned.
(60) Provisional application No. 61/722,253, filed on Nov. 5, 2012.

(51) Int. Cl. G06Q 50/22; G06F 3/0484

(52) U.S. Cl. CPC G06Q 50/22; G06F 3/0484

(57) ABSTRACT

An interactive healthcare accountability and support system includes a server having a processor, memory having a database and storing instructions, and a tool box to establish controls that are set to dynamically and algorithmically compile and transform health related data and information displayed on multiple GUIs without requiring new or changes to the stored instructions. Client devices are coupled to the server, each having a processor and devices for inputting and viewing algorithmically compiled and transformed health related data and information. The GUIs including first GUIs and second GUIs. The first GUIs are selectively customizable by parameters to collect, analyze and dynamically display an action plan for the patient based on health related data and information input by the patient. The second GUIs, accessible by a user different than the patient, include tools and functions to dynamically customize the first GUIs in real time.

### CROSS REFERENCE TO RELATED APPLICATIONS

This patent application is a continuation of and claims priority benefit under 35 U.S.C. Section 120 to copending U.S. Continuation-in-Part patent application, Ser. No. 14/143,642, filed on Dec. 30, 2013 (Atty. Docket 1102-0008-1CIP), which is a continuation-in-part of and claims priority benefit under 35 U.S.C. Section 120 to copending, U.S. Non-provisional patent application Ser. No. 14/072,451, filed Nov. 5, 2013 (Atty. Docket 1102-0008-1), which claims the benefit under 35 U.S.C. Section 119(e) of U.S. Provisional Patent Application Ser. No. 61/722,253, filed Nov. 5, 2012. The disclosures of these US patent documents are incorporated by reference herein in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### TECHNICAL FIELD

The present invention relates generally to systems and methods for capturing data and for providing information and services in the field of healthcare. More particularly, the present invention relates to systems and methods for providing selectively adaptable user interfaces that collect and present health related data and information from and to a plurality of stakeholders. The interfaces are selectively customizable by tools or controls within an administrative toolbox that enables real-time dynamic implementation of modifications to the interfaces without implementing underlying programming changes.

### BACKGROUND OF THE INVENTION

Generally speaking, there is an on-going demand for reliable, affordable healthcare support tools. As with any product or service, knowledge and involvement in decision making are important factors in obtaining consumer satisfaction, health and cost outcomes. Within the area of healthcare, many resources are spent in the creation and exchange of information. For example, one need only perform a search on the Internet to uncover tens of thousands of pages of health related information. However, among the stakeholders within the healthcare community including, for example, patients, care providers, employers, payers, government institutions and the like, communication of information relevant to a particular consumer appears limited. As such, it can be burdensome to locate information, contribute data, manage action steps and obtain feedback in one end user location that enables the consumer to be a knowledgeable, fully involved participant of their own healthcare.

Accordingly, the inventor has recognized that there is a need for a system and method that captures data and provides information and services in the field of healthcare that employs selectively adaptable user interfaces such that content (e.g., data and information, tools and/or functions including, for example, dynamic assessments, action plans and progress reports) can be dynamically managed and presented to participants in real-time in a convenient, appealing and cost efficient venue to improved meaningful participation in healthcare.

### SUMMARY OF THE INVENTION

Based on the foregoing, the present invention provides an interactive healthcare accountability and support system including a server computer, a plurality of client devices operatively coupled to the server computer over a communication connection and a content database operatively coupled to the server computer. The server computer includes a server processor and a server memory storing a plurality of instructions executable by the server processor. Each of the client devices includes a client processor, an input-output controller and input-output devices for inputting and for viewing health related data and information. The content database receives and stores the health related data and information. The server processor of the healthcare system is configured to provide a first plurality of graphical user interfaces (GUIs) customizable to collect and present the health related data and information from and to a plurality of stakeholders, and a second plurality of GUIs including tools and functions to customize the first plurality of GUIs without modification to the instructions within the server memory. In one aspect of the invention, the ability to customize the first GUIs provides highly efficient adaptability down to the word level while avoiding the need for programming new or unique code for each use case instance, assessment, report or content display.

In one embodiment, the interactive healthcare accountability and support system further includes an administrative toolbox. The toolbox provides the tools and functions of the second plurality of GUIs to dynamically manage the health related data and information based on individual profiles of the plurality of stakeholders. In one embodiment, the health related data and information supports at least one of health, quality and performance improvements, cost and payment management, and for research purposes. In one embodiment, the health related data and information includes patient or organization data and information including a patient's, a provider's or an organization's profile having identification information, billing information, information and data defining the patient's age, gender, health and one or more conditions of the patient. The health related data and information also includes assessment data and information including assessments gauging a patient's progress along a predetermined action plan or treatment protocol, progress toward a relatively more healthy state or condition, and general preferences and/or recommendations on the action plan. The health related data and information further includes accumulation data and information including accumulations or tallies of general health trends within a predetermined population and/or one or more time periods. The health related data and information further includes preference data and information including values and parameters that are used by the administrative toolbox to customize the first plurality of GUIs. In one embodiment, the parameters of the preference data and information include dynamic url strings paired to one or more of an individual patient, provider and or organizational users by a unique user identification code, to one or more assessments by an assessment identification code and to one or more topics by a topic identification code.

In one embodiment, the administrative toolbox provides the tools and functions to dynamically modify, for example: specific text, ordering of text or other items presented on the first plurality of GUIs and to include branching logic between and among related questions or topics; assign a scoring dimension and/or sub-dimension to items within assessments of a stakeholder's health; assign a response type with response choice wording and whether or not that response on the rating scale represents a gap or opportunity for improvement; assign scores for each response choice on each rating scale within the assessments of the stakeholder's health; provide unique messaging to the stakeholder based on his/her responses falling into a predetermined score range; define next step actions embedded in messaging to guide stakeholders toward improved health and to include, but not be limited to, linking back to topics in a resource center; selectively present or inhibit presentation of previous answers on the assessment; and assign unique titles, branding and instructions based on stakeholder profiles. In one embodiment, the administrative toolbox provides the tools and functions to dynamically modify at least one of: specific images, titles as well as one of position, orientation and highlighting of text presented on the first plurality of GUIs; locations for retrieving content presented on the first plurality of GUIs; and interrelationship between items of content within a tree structure.

### BRIEF DESCRIPTION OF THE DRAWINGS

The features and advantages of the present invention will be better understood when the Detailed Description of the Preferred Embodiments given below is considered in conjunction with the following figures.

FIG. 1 is a schematic block diagram of an exemplary system for providing and selectively controlling user interfaces that collect and present health related data and information from and to a plurality of stakeholders, in accordance with one embodiment of the present invention.

FIGS. 2 and 3 are schematic block diagrams of the system of FIG. 1 employed within a continuum of healthcare.

FIGS. 4 to 6 depict exemplary graphical user interfaces (GUIs) for user creation and definition, in accordance with one embodiment of the invention.

FIG. 7 depicts one embodiment of a content management system GUI, in accordance with the invention.

FIG. 8 depicts one embodiment of an administrative control GUI for the content management system GUI of FIG. 7.

FIGS. 9 and 9A depict embodiments of welcome GUIs that provide users access and visibility to tools and functions of the system of FIG. 1.

FIGS. 10 and 10A depict embodiments of user specific health topics GUIs invoked from the welcome GUIs of FIGS. 9 and 9A, respectively.

FIG. 11 depicts one embodiment of a user specific health content GUI invoked from the health topic GUI of FIG. 10.

FIG. 12 illustrate fields of a content database of the system of FIG. 1 that store data employed to present user specific content, tools and/or functions on the GUIs in accordance with one embodiment of the present invention.

FIG. 13A depicts one embodiment of a consumer/provider resource center GUI that provides access to information, tools and functions of the system of FIG. 1.

FIG. 13B depicts one embodiment of an organization resource center GUI that provides access to information, tools and functions of the system of FIG. 1.

FIGS. 14A to 14C depict exemplary embodiments of navigational controls for providing access to content within the system of FIG. 1.

FIGS. 15 to 18 depict exemplary embodiments of administrative control GUIs for customizing the topics, information, tools and/or functions presented on the consumer/provider and organization resource center GUIs of FIGS. 13A and 13B.

FIG. 19 depicts one embodiment of a user specific assessment GUI that provides access to previous and new assessments, surveys and/or questionnaires available within the system of FIG. 1 to support any quality or performance improvement, cost or payment management or for research purposes.

FIG. 20 depicts one embodiment of an assessment GUI including questions and optional responses in accordance with the present invention.

FIGS. 21 and 22 depict portions of an assessment and action plan embedded within health topic GUIs in accordance with one embodiment of the present invention.

FIGS. 23 and 24 depict exemplary embodiments of administrative control GUIs for customizing the topics, question content, answer options, tools and/or functions presented on the assessment and action plans within the GUIs of FIGS. 21 and 22.

FIG. 25 depicts one embodiment of a summary progress report GUI that highlights a user's progress in categories including learning, areas for discussion, and completion of actions.

FIG. 26 depicts one embodiment of a detail progress report GUI that highlights a user's specific progress in a healthcare area of interest.

FIG. 27 depicts a healthcare professional's report generator GUI that provides access to one or more reports in accordance with one embodiment of the present invention.

FIG. 28 depicts one embodiment of an improvement opportunities gap report GUI that provides visibility to one or more areas within assessments, surveys, questionnaires, or other input from users that highlight actual or perceived deficiencies, inadequacies and/or other areas for improvement in quality, efficiency or other issues in the delivery of healthcare services and/or resources.

FIGS. 29 to 31 depict exemplary embodiments of administrative control GUIs for defining and/or modifying reports invoked by the healthcare professional's report generator GUI of FIG. 27.

FIG. 32 depicts one embodiment of a rewards and discounts that provides access and/or links to one or more rewards and/or discounts programs made available to users of the system of FIG. 1.

In these figures like structures are assigned like reference numerals, but may not be referenced in the description of all figures.

### DETAILED DESCRIPTION OF THE PREFERRED EMBODIMENTS

The present invention is directed to web-based systems and methods for providing information and services in the field of healthcare utilizing one or more selectively customizable graphical user interfaces (GUIs) that collect and present health related data and information from and to a plurality of stakeholders. The stakeholders include, for example, patients including persons responsible for patients such as parents or guardians, or persons participating in making health decisions for the patients, healthcare providers including doctors, nurses, health institutions and like care givers, and insurance companies, employers or governmental institutions or any of their subcontractors delivering to a company health service offerings and/or administering health programs and benefits. As described herein, the GUIs are selectively customizable by tools or controls within an administrative toolbox that enable real-time implementation of modifications to the GUIs without implementing underlying programming changes. As such, content provided to and/or data collected by the system may be dynamically managed (e.g., added, changed, deleted or otherwise modified) in both a cost and a time efficient fashion to adapt to varying clinical needs and/or uses across a full spectrum of healthcare conditions from, from example, general health and wellness conditions, to chronic and acute care conditions, to end of life conditions. The customizable GUIs within the web-based healthcare systems and methods provide what is referred to herein as a HEALTHCAWS® Accountability and Support Platform. As described herein, the HEALTHCAWS® Platform provides patients and consumers, while not in the healthcare system, an ability to take responsibility for and to be an active participant in their health care by being a more informed consumer of such services, e.g., a more informed purchaser that can comparison shop based on value, quality and other factors. The platform provides healthcare providers with a mechanism to communicate with patients and address their expectations for services and accountability, identify outstanding issues or needs, participate in quality programs, and understand uses of healthcare resources including recognizing misuses such as overuse as well as underuse of resources. Similarly, the platform provides organizations with an ability to assess its healthcare offerings, promote further understanding of patient and provider needs, improve efficiencies and minimize, if not eliminate, waste and otherwise improve the value of the resources provided. The HEALTHCAWS® Platform includes the tools and controls within the administrative toolbox for implementing an improved content and user control and management system. HEALTHCAWS is a registered trademark of Rosemarie D. Maljanian, the inventor of the present invention, of Farmington, Conn. USA.

As described herein customizable GUIs can be accessed via an internet web site address (e.g., URL) hosted by a server computer to enter, review, update, or select data and information pertaining to healthcare. The terms “user,” “patient,” “healthcare provider,” “care provider,” and/or “administrator” as used herein are intended to broadly embody one or more persons acting individually, acting for another or acting for a group or department within a company or other organization that carries out activities including making healthcare decisions, providing and/or administering health programs and benefits. Each user can access healthcare data and information of an individual patient (with proper authorization from the patient or his/her guardian), or of an accumulation of patients within a predetermined population (e.g., normalized or de-sensitized to remove personally identifiable information and the like). The GUIs can be customized for the user by an administrator and, to a certain extent, by an authorized user.

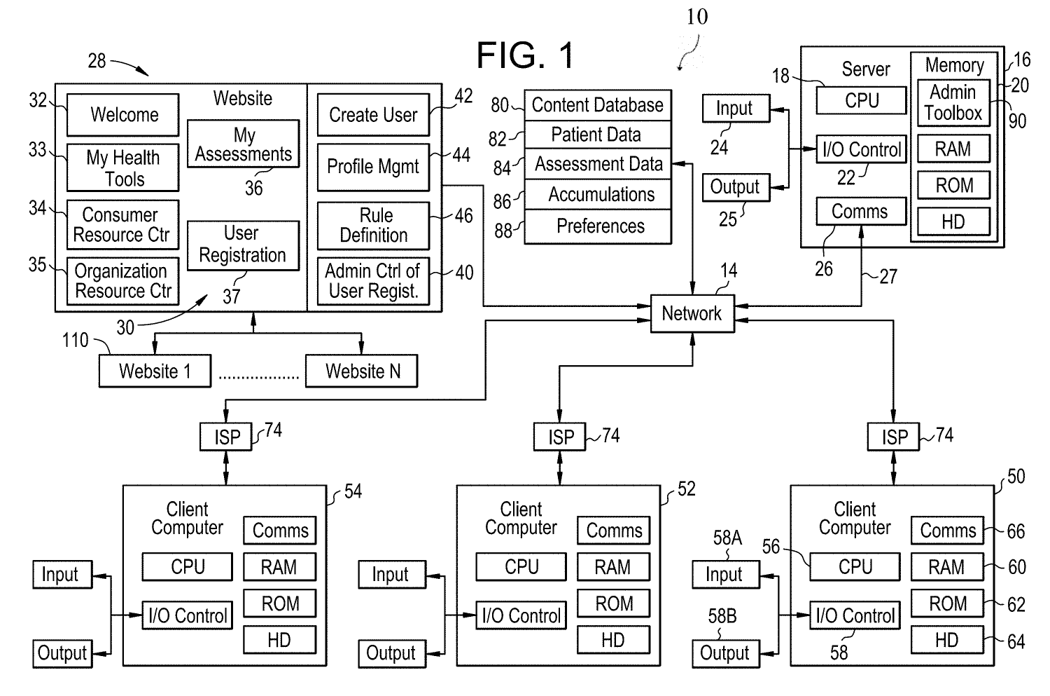

FIG. 1 illustrates an exemplary embodiment of the HEALTHCAWS® Platform, shown generally at 10, configured and operating to implement instructions and algorithms for providing information and services in the field of healthcare utilizing one or more selectively customizable, graphical user interfaces (GUIs) 30 that collect and present health related data and information from and to a plurality of stakeholders, as described herein. The HealthCAWS platform 10 includes a server computer or server 16 having a server central processing unit (CPU) 18, server memory 20 that can include random access memory (RAM), read only memory (ROM), a hard drive (HD), and the like, input/output controller (I/O Control) 22 operatively coupled to input 24 and output 25 devices such as a keyboard, mouse, light pen or other pointing device, a document, card or other medium reader or scanner, a printer, a monitor, touch screen or other display device for facilitating input to and output from the platform 10 of data and information, and an electronic communication apparatus (COMMS) 26 for communicating, as indicated by reference numeral 27, with a computerized communication network 14 such as, for example, the Internet, an intranet, an extranet, or like distributed communication platform connecting computing devices over wired and/or wireless connections. The server CPU 18 executes computer-implemented algorithms and instructions residing in memory 20 to implement the HealthCAWS platform 10, including an administrative toolbox 90 having GUIs 40 providing tools or controls as described herein for modifying the GUIs 30.

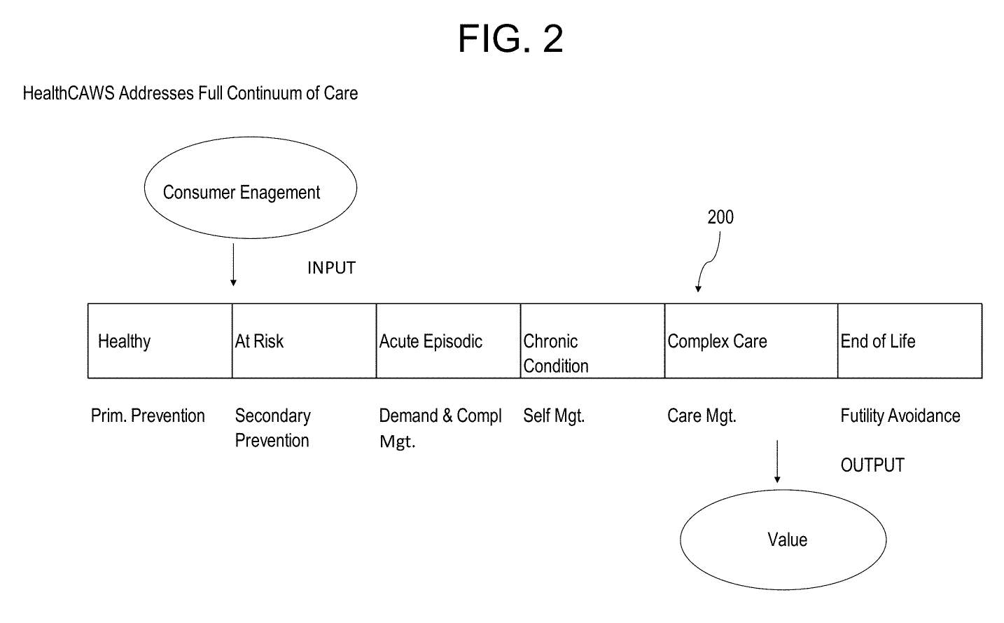

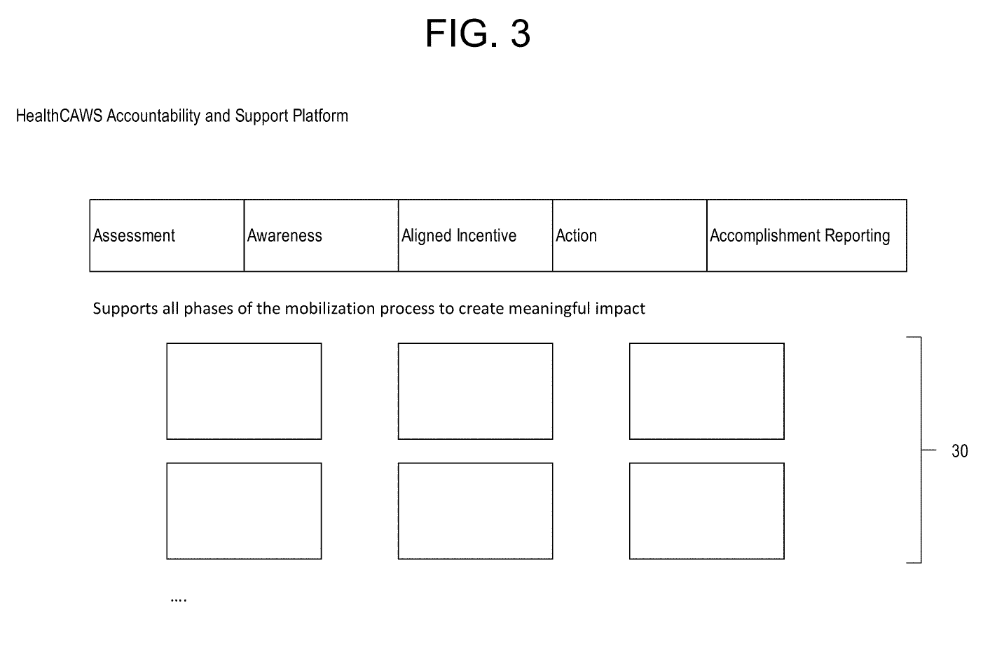

The server 16 accesses a content database 80 directly or through the network 14. The content database 80 receives and stores a patient's or an organization's data and information 82 including a patient's or organization's profile including identification information, billing information, information and data defining the patient's age, gender, health and one or more conditions of the patient, assessment data and information 84 including assessments aimed at gauging a patient's progress along a predetermined action plan or treatment protocol, or toward a relatively more healthy state or condition, general preferences and/or opinions on the action plan or treatment protocol or the like, accumulation data and information 86 including accumulations or tallies of general health trends and the like within a predetermined population and/or one or more time periods, and preference data and information 88 including values, parameters and the like that may be used by the administrative toolbox 90 to customize one or more GUIs 30 to a user's needs. It should be appreciated that in one embodiment, patient data may not be stored in the content database 80 for security and/or regulatory compliance reasons. As described below, in one embodiment, the action plans and/or treatment protocols may be based upon recommended treatment for persons with similar conditions as set by an administrative and/or health industry standard or the like, and may address primary prevention, secondary prevention, demand and compliance management, patient and care provider self management, care management and futility avoidance across a full spectrum of healthcare conditions 200 from, from example, general health and wellness conditions, to chronic and acute care conditions, to end of life conditions as illustrated in FIGS. 2 and 3.

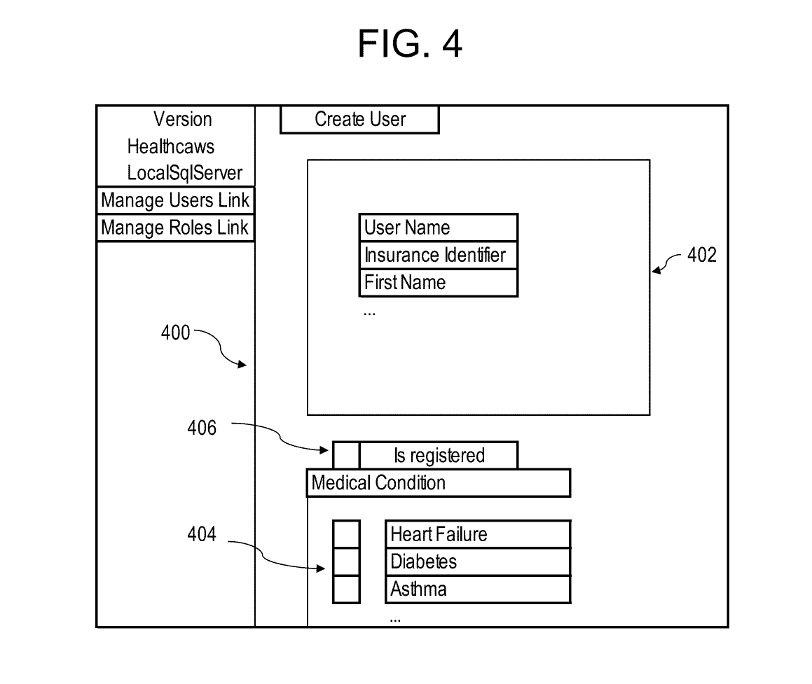

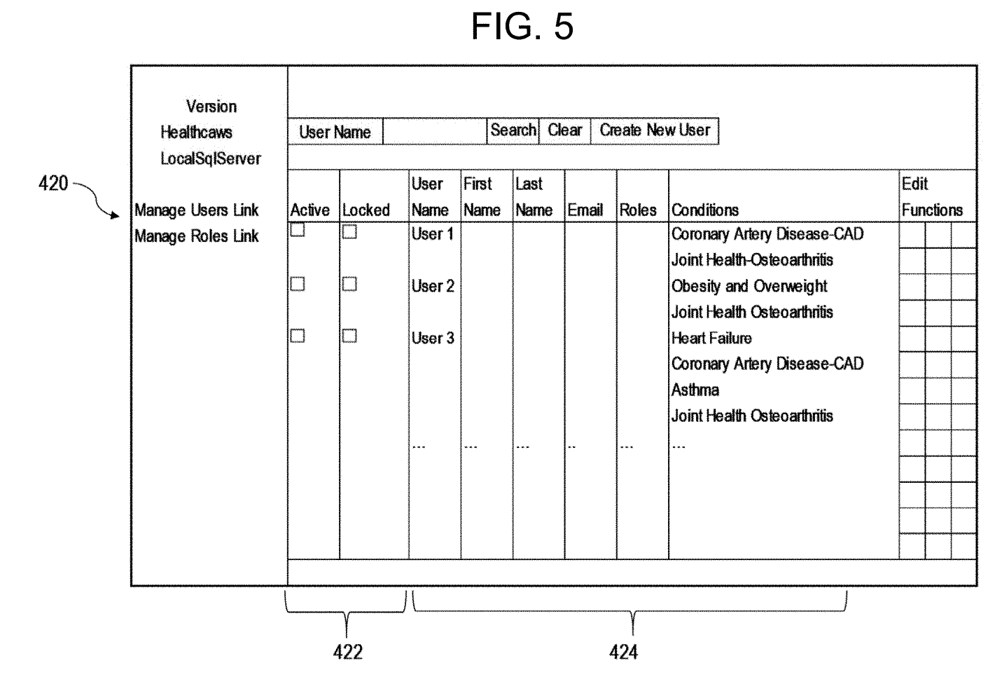

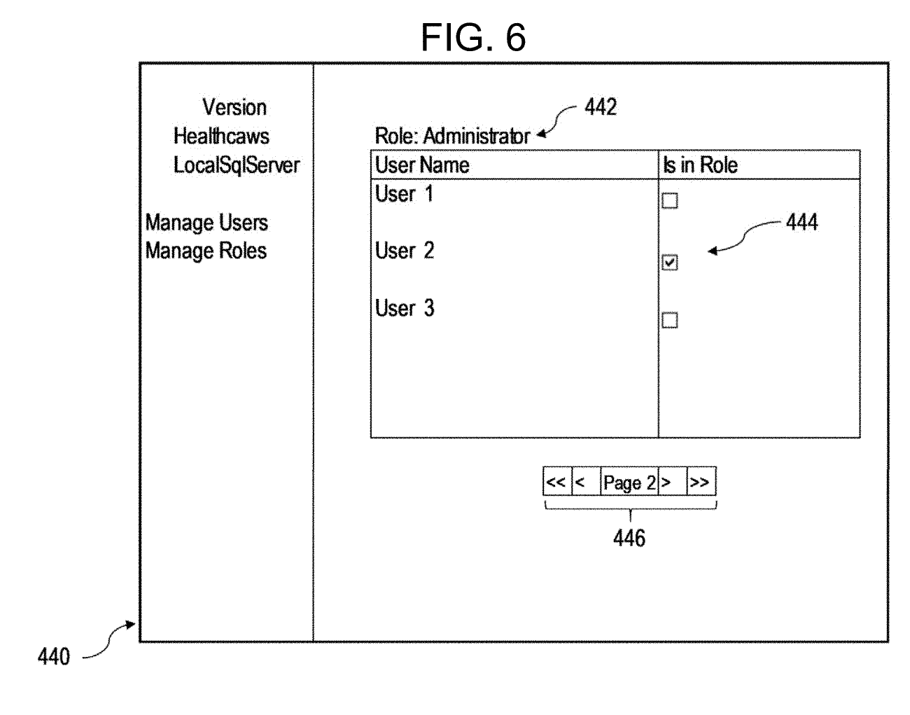

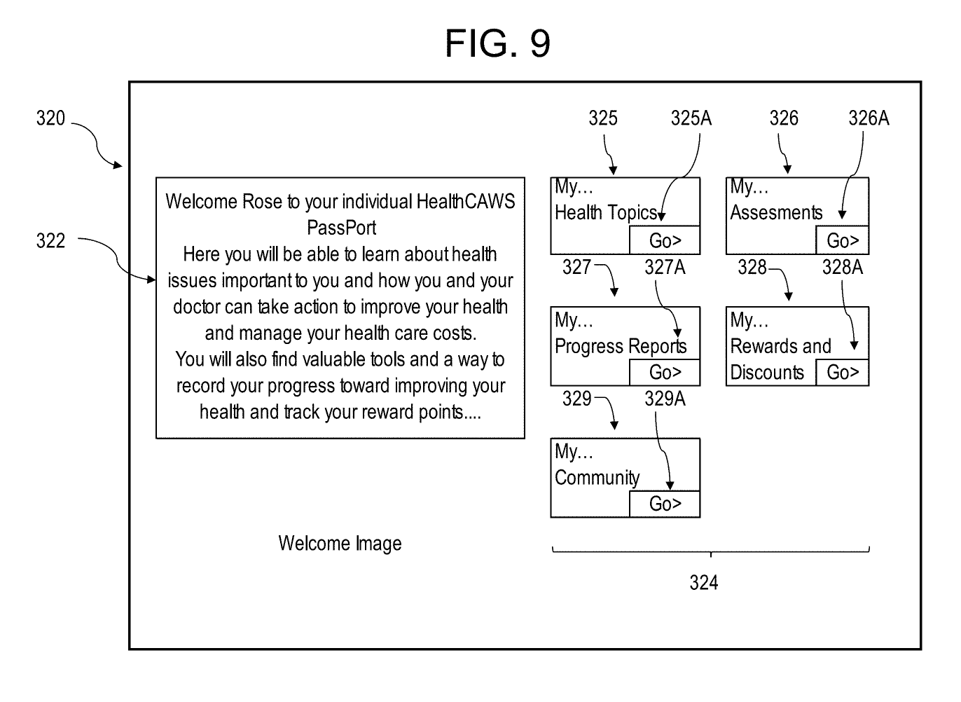

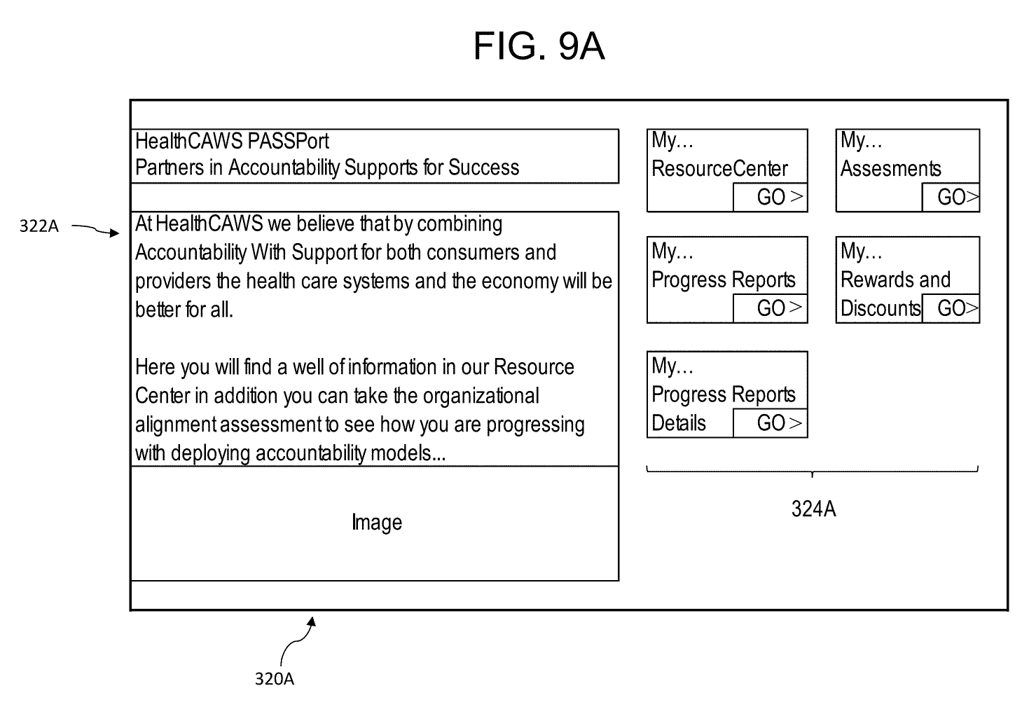

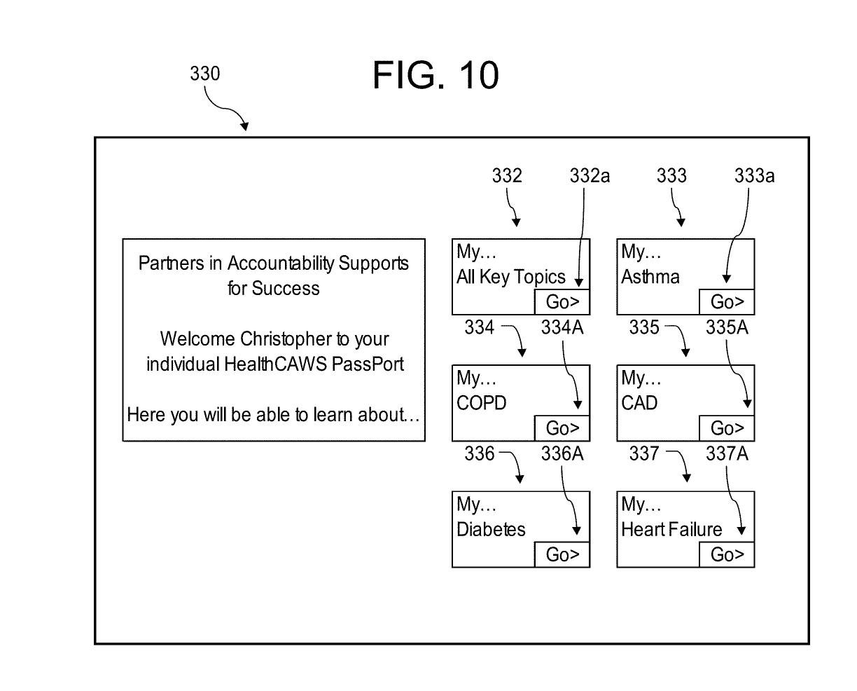

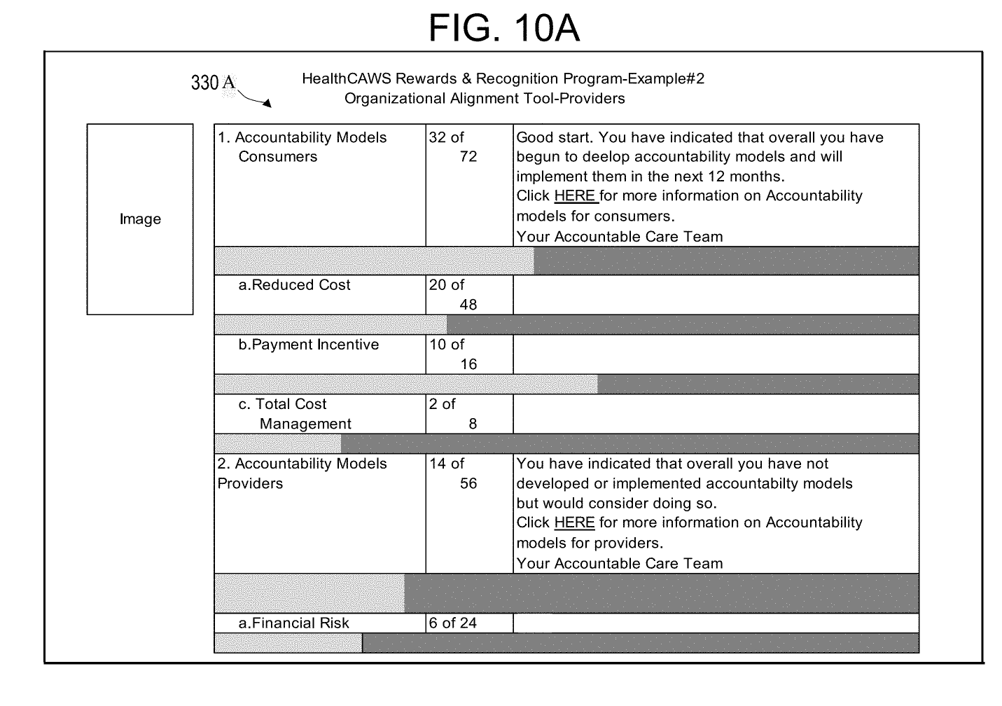

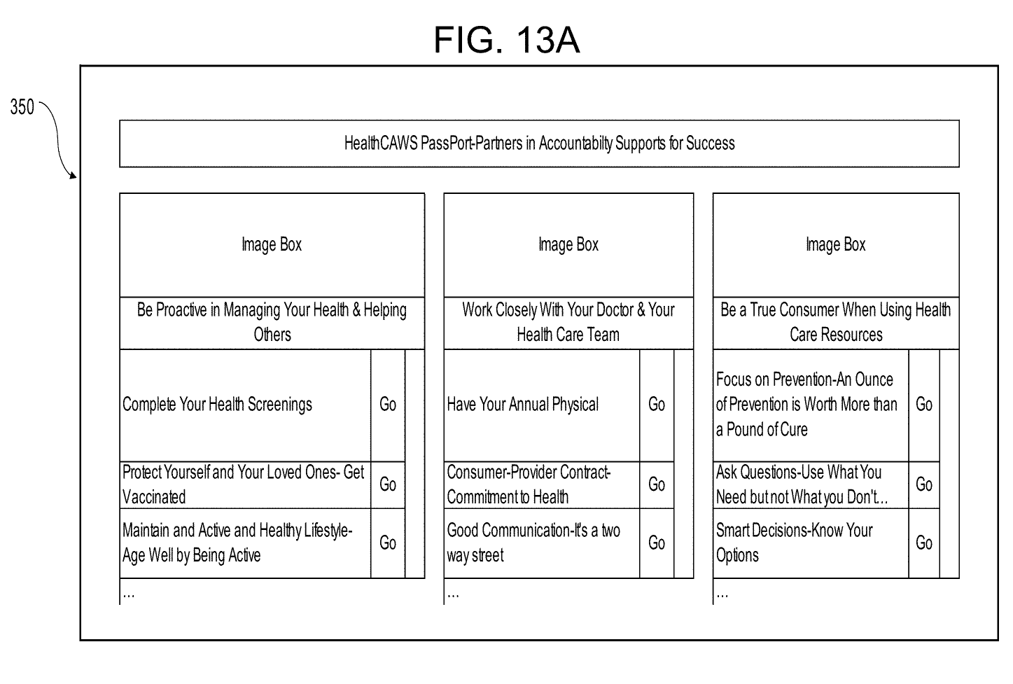

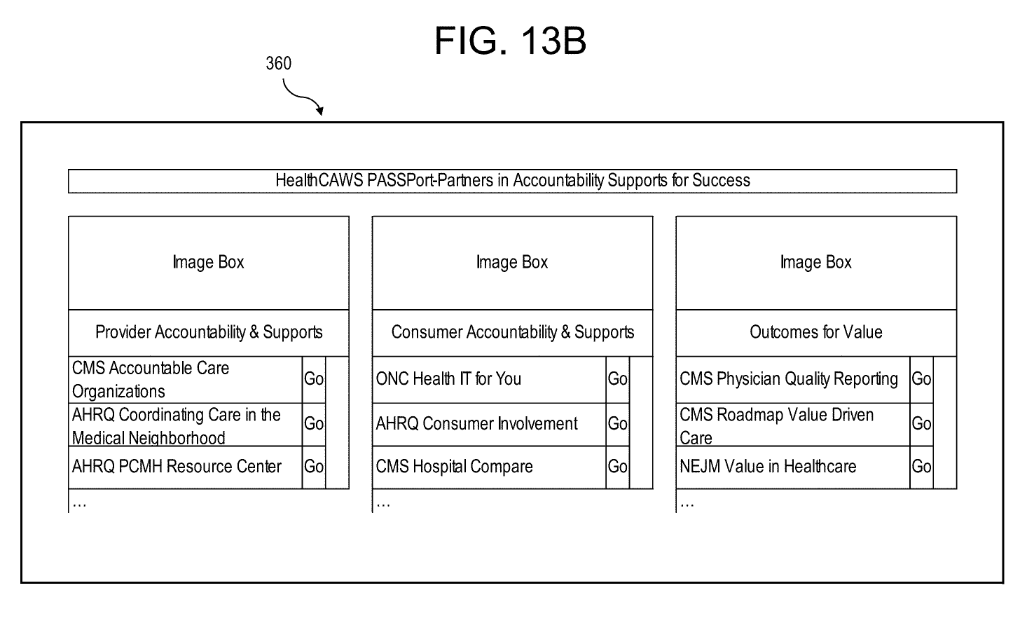

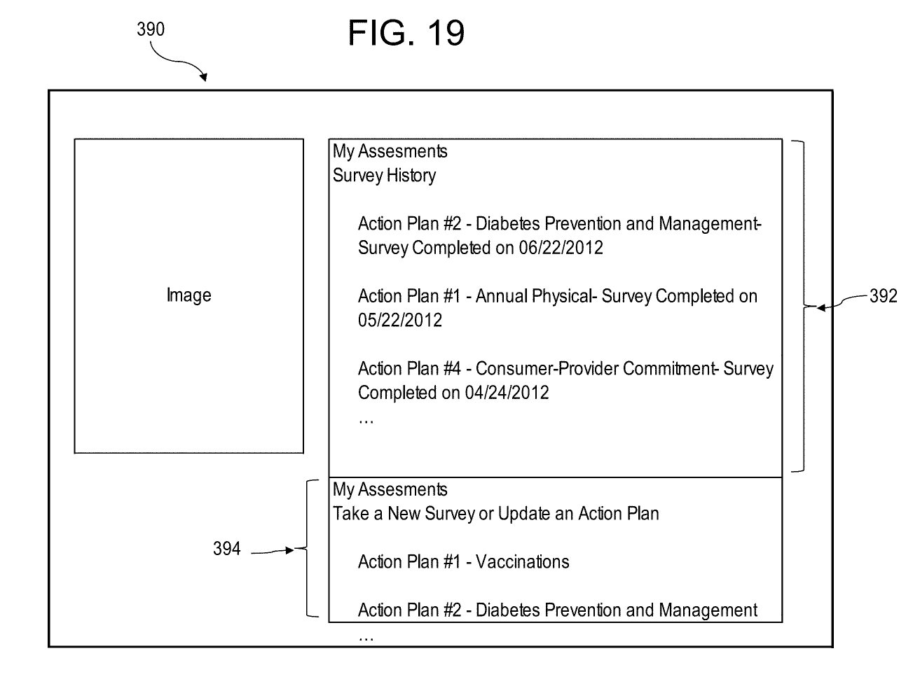

Referring again to FIG. 1, the server 16 hosts a user interface such as a web site 28 having a plurality of GUIs 30 including, for example, a Welcome or home page GUI 32 (e.g., a Welcome GUI 320 of FIG. 9), a My Health Topics page GUI 33 providing access to individual health topics detail pages (e.g., a My Health Topics GUI 330 of FIG. 10), for example, driven by definitions within the user's individual profile, a Consumer/Provider Resource Center—All Topics page GUI 34 (e.g., a Consumer/Provider Resource Center GUI 350 of FIG. 13A) providing access to general health topics detail pages including, for example, healthcare quality assessment pages, an Organization Resources Center—All Topics page GUI 35 (e.g., an Organization Resource Center GUI 360 of FIG. 13B) providing access to general organizational health topics pages, and a My Assessments Display/Access page GUI 36 (e.g., a My Assessments GUI 390 of FIG. 19). It should be appreciated that the web site 28 also includes a plurality of GUIs 40 invoked by the administrative toolbox 90 and including tools and/or controls as described herein for modifying the GUIs 30 and/or managing users (e.g., stakeholders). For example, the GUIs 40 include a User Definition GUI 42 (e.g., a Create User GUI 400 of FIG. 4) for establishing a new user profile on the platform 10, a User Profile Management GUI 44 (e.g., a User Profile Management GUI 420 of FIG. 5), and a User Role Definition GUI 46 (e.g., a User Role GUI 440 of FIG. 6).

In one embodiment, the User Profile Management GUI 44 allows the administrator user to search and/or edit users and create new users, the User Role Definition GUI 46 allows the administrator user to set or revoke privileges of all other user types down to the individual user. Users are created manually or dynamically populated in real-time through a variety of live web connections allowing the administrator to view and monitor new users instantly as they are added to the authenticated user population. Users that are not authenticated are blocked and do not pass through into the user management system therefore obtain no user privileges.

The web site 28 may be requested by users of the HealthCAWS platform 10 through designation of a Uniform Resource Locator (URL) identifying the web site 28, web page GUIs 30 (e.g., GUIs 32 to 36) and web page GUIs 40 (e.g., GUIs 42 to 46), and providing access to the server 16 from other computing devices on the network 14. In one embodiment, access to the web site 28 and web page GUIs 30 and 40, and/or selected portions thereof, and/or to selected services and functionality provided by the HealthCAWS platform 10, is restricted to registered (e.g., “member”) users, as is described below, executing programs such as, for example, web browser software to request, receive and process the web site 28 and web page GUIs 30 and 40. The web page GUIs 30 and 40 are generally written in a language that permits a graphical presentation of data and information (text, images, audio, video, and the like) to persons operating a computing device. Languages include for example, the Hyper-Text Markup Language (HTML), Extensible Markup Language (XML) or another Standard Generalized Markup Language (SGML), as are generally known in the art.

As will be described in greater detail hereinafter, the GUIs 30 can be customized by the administrative toolbox 90 invoking the GUIs 40 and the tools and/or controls therein for modifying the GUIs 30 and the health related data and information collect from and presented to the plurality of stakeholders operating the HealthCAWS platform 10. As noted above, this data and information is stored in the content database 80.

As shown in FIG. 1, the HealthCAWS platform 10 includes a plurality of user or client computers 50, 52 and 54 operable by users (e.g., one or more of the aforementioned stakeholders) to enter, view or retrieve data and information from the web site 28. Each of the user computers 50, 52 and 54 includes a user computer central processing unit (CPU) 56, an input-output controller (I/O Control) 58 operatively coupled to input 58A and output 58B devices such as a keyboard, mouse, light pen or other pointing device, a document, card or other medium reader or scanner, a printer, a monitor, touch screen or other display device for facilitating input to and output from the HealthCAWS platform 10 of data and information, user computer memory that can include RAM 60, ROM 62, and a hard drive 64, and an electronic communication apparatus (COMMS) 66 for communicating with server computer 16 over the network 14. The COMMS 66 can include a modem or a connection to a local area network (LAN), either of which can access an internet service provider (ISP) 74 through a wired or wireless communication line such as a telephone network, television cable lines, satellite links, DSL lines, or the like. The user computers 50, 52 and 54 may be an IBM-type or Apple Personal Computer (or compatible analogs thereof), a terminal computer, or other computing device suitable for running a browser program for accessing and communicating over the network 14 including, for example, a workstation or a portable computing device such as, for example, a personal digital assistant (PDA), smart phone such as a BlackBerry, iPhone, or the like, an iPad, an Android device, a tablet or notebook computer, or any other known device that is capable of executing a browser program or other application for communicating over the network 14.

As noted above, the computers 16, 50, 52, and 54 can include the electronic communication apparatus 26 and 66, respectively. The term “electronic communication apparatus,” as used herein, refers to an apparatus that facilitates electronic communication with another computer using a selected interconnection mechanism, such as a telephone network, a LAN, an intranet, or the Internet, and a selected communication protocol, such as V.90 or V.32, or in the case of the Internet, TCP/IP. The electronic communication apparatus can also include wireless or IR communication mechanisms. Electronic communication apparatus also includes circuitry that provides parallel, serial, Scsi, USB, Firewire, and other such ports known in the art, and protocols such as, but not limited to, Appletalk. The foregoing are merely examples of electronic communication apparatus, and the present invention is not limited to these examples.

Referring now to FIGS. 4 to 6, embodiments are shown of User Management and Role Definition GUIs 400, 420 and 440 (e.g., embodiments of the GUIs 40 for managing users and their roles in the platform 10), utilized in the HealthCAWS platform 10 by for example, an administrator or other authorized user. For example, as shown in FIG. 4, a Create User GUI 400 is depicted. In one embodiment, the Create User GUI 400 includes fields 402 for establishing and/or identifying a new user on the platform 10, his/her contact information, health provider information, and the like. The Create User GUI 400 also includes fields 404 for identifying one or more health conditions of the new user. In one embodiment, the HealthCAWS platform 10 directs features and functions (e.g., provides access to and/or customizes displays) based on identified health conditions of the new user. In one embodiment, the user may be granted or denied access to the HealthCAWS platform 10 or portions thereof based on the conditions and/or a flag or indication such as, for example, that the new user is or, is not, a registered user, shown generally at 406. In one embodiment, illustrated in FIG. 5, a User Profile Management GUI 420 includes fields 422 for locking (e.g., labeled “Locked”) or unlocking (e.g., labeled “Active”) the user's profile and access to the HealthCAWS platform 10 or portions thereof. The User Profile Management GUI 420 also includes fields for updating one or more of the user's credentials on the HealthCAWS platform 10. In one embodiment, the HealthCAWS platform 10 includes one or more roles and/or privileges on the platform 10. For example, in one embodiment illustrated in FIG. 6, a User Role Definition GUI 440 includes fields 442 that define a role such as, for example, an administrator for the platform 10, and permits appointing one or more users to the specified role by, for example, selection of field or flag 444 that authorizes the users within the specified role within the HealthCAWS platform 10. As shown generally at 446, in one embodiment, the entire or a subset of the population of users within the HealthCAWS platform 10 may be appointed by operation of the User Role Definition GUI 440 to cycle through all users of the platform and selectively make appointments. In one embodiment, the User Management Roles system allows for setting privileges via the administrative controls. For example, “standard” users have front end GUI access (e.g., access to the GUIs 30) to their own dynamically set screens, tools and reports, “administrator” user have access or privileges that uniquely includes a full battery of controls including, for example, an ability to set roles of other users, delete, manage access and passwords of all users, review all results/reports and ability to customize any tool or content down to the word level, and “provider” users (including, but not limited to, for example, doctors, nurses, care managers, case managers, health coaches, pharmacists and the like) have privileges that allow access to assessment and action plan status/results where there is an authorized one to one mapping between a patient and a provider or care manager.

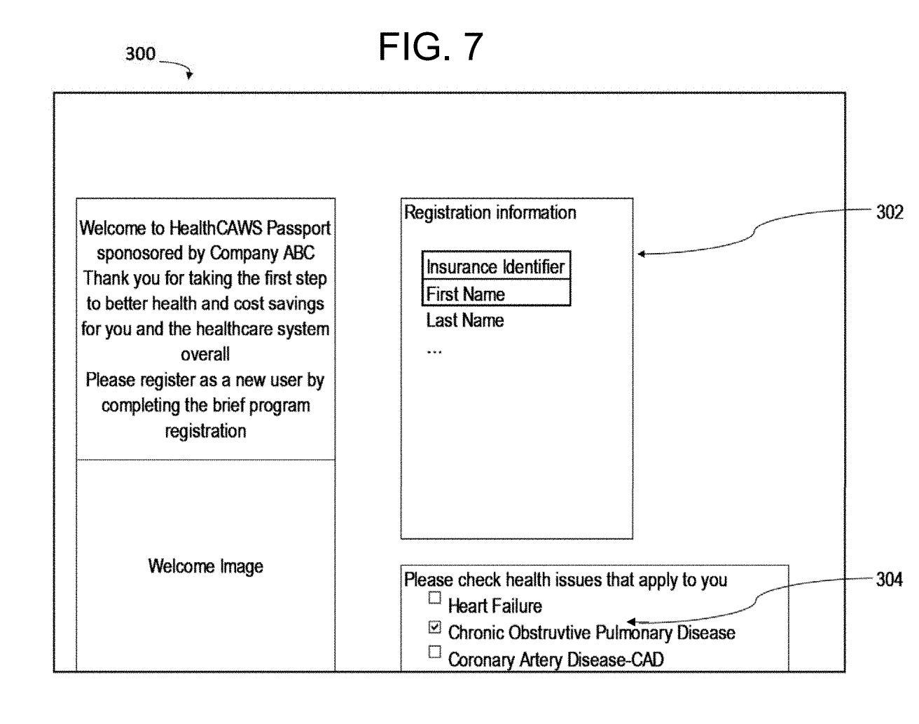

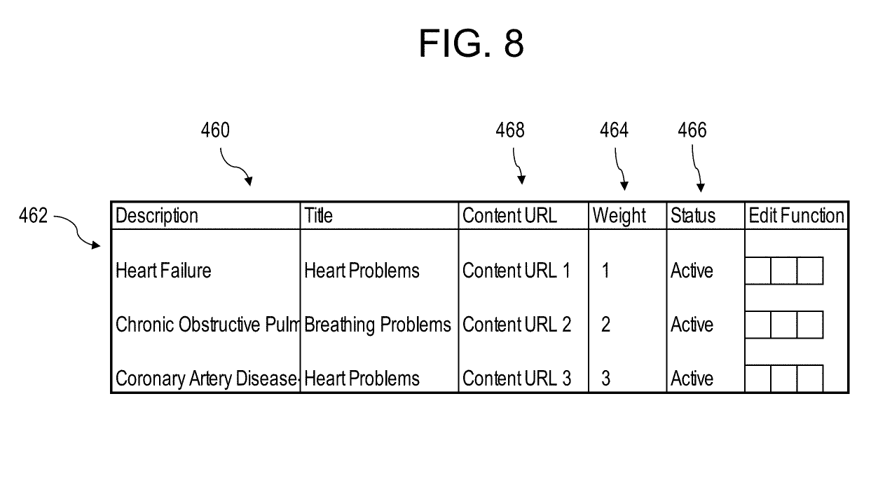

In one embodiment, illustrated in FIG. 7, new users may register themselves with the HealthCAWS platform 10 utilizing one of the GUIs 30, for example, a Content Management System GUI 300. As shown in FIG. 7, the Content Management System GUI 300 includes fields 302 and 304 that are similar to the fields 402 and 404 of the administrator operated Create User GUI 400. For example, the fields 302 permit a user to enter his/her age, gender, contact information, health provider information, and the like, and the fields 304 that permit the user to identify one or more of their health conditions. In one embodiment illustrated in FIG. 8, it is within the scope of the present invention for the administrator or other authorized user to control (e.g., define) presentation of the fields 302 and 304 of the Content Management System GUI 300, and/or portions thereof, through operation of an Administrative Control of Content Management System GUI 460. For example, as shown in FIG. 8, labels or descriptions 462 of the fields 304 are customizable on the Administrative Control of Content Management System GUI 460 which corresponds to the selectable descriptions on the fields 304. In one embodiment, modification of the text of the labels or descriptions 462 results in presentation of the modified text on the corresponding fields 304 of the Content Management System GUI 300. Similarly, an order or ranking of presentation of the fields 304 may be controlled by a weight field 464, and/or presentation or non-presentation of the fields 304 may be set by a status field 466 on the Administrative Control of Content Management System GUI 460. In one aspect of the invention, a location of content that may be presented to a user that specifies one of the conditions noted in the fields 304 is defined by a Content URL field 468 on the Administrative Control of Content Management System GUI 460. In this manner, content may be dynamically changed in real-time by, for example, modifying a corresponding one of the Content URL fields 468 to point to a new location.

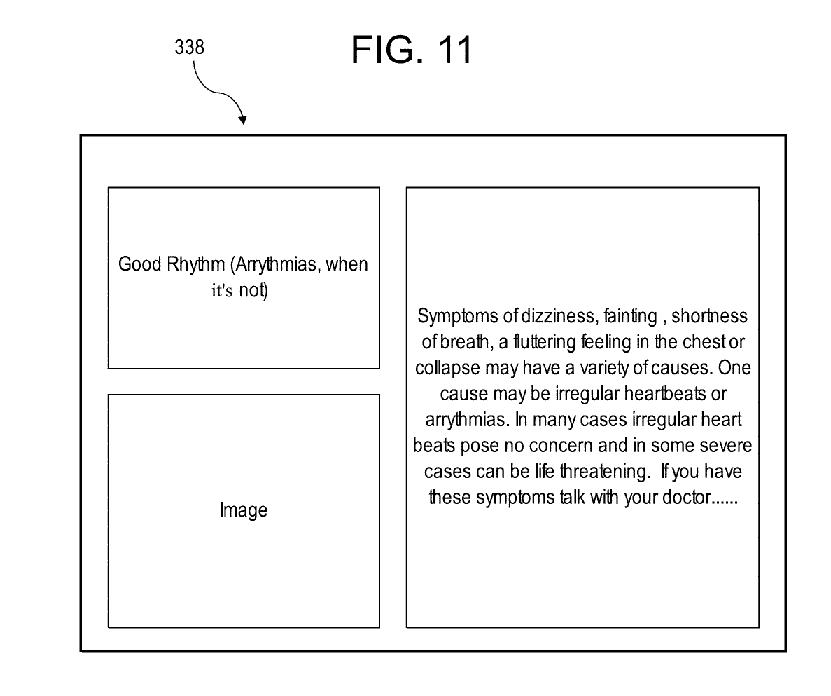

FIG. 9 depicts one embodiment of a Welcome GUI 320 of the HealthCAWS platform 10 (e.g., an embodiment of the Welcome or home page GUI 32) presented to, for example, an individual patient stakeholder. In accordance with the present invention, the Welcome GUI 320 is a “passport” providing the patient user access and visibility to tools that allow them to take responsibility for and to be an active participant in their health care by being a more informed consumer of such services, e.g., a more informed purchaser that can comparison shop based on value, quality and other factors. In one embodiment, the data and information 82 and 88 including the user's profile and preferences is retrieved from the content database 80 and used to create a unique, user specific presentation of topics 322 and tools and/or functions 324. For example, the tools and/or functions 324 may include health topics function 325, an assessments function 326, a progress reports function 327 and a rewards, recognitions or discounts function 328 customized by the HealthCAWS platform 10 based on characteristics of the user's profile. It should be appreciated that the topics 322 and tools and/or functions 324 presented are not limited, and are dynamically modified as the user's profile and/or platform functionality changes. As shown in FIG. 9, the presented tools and/or functions 325, 326, 327 and 328 include one or more “Go” controls or buttons 325A, 326A, 327A and 328A that invoke additional more specific tools or functions that cascade to a more defined level of detail. For example, selecting the Go button 325A on the My Health Topics function 325 of FIG. 9 invokes a more specific My Health Topics GUI 330 of FIG. 10. As shown in FIG. 10, the tools and/or functions 324 of FIG. 9 are replaced with a general All Key Topics function 332, and with specific topics or conditions functions that are developed from the user's profile, for example, an Asthma function 333, a Chronic Obstructive Pulmonary Disease (COPD) function 334, a Coronary Artery Disease—CAD function 335, a Diabetes function 336 and a Heart Failure function 337. As shown in FIG. 10, the presented functions 332, 333, 334, 335, 336 and 337 each include Go buttons that invoke further detailed content. For example, a Go Button 335A of the Coronary Artery Disease—CAD function 335 invokes specifically related health topic content such as an overview of Good Rhythm 338 presented in FIG. 11.

FIG. 9A depicts another embodiment of a Welcome GUI 320A of the HealthCAWS platform 10 (e.g., an embodiment of the Welcome or home page GUI 32) presented to, for example, users of an organizational stakeholder to support any quality or performance improvements, cost or payment management, or for research purposes. In accordance with the present invention, the Welcome GUI 320A is a “passport” providing the organizational user access and visibility to tools that allow them, for example, to be a more responsive provider of health care services to improve value, quality and other factors for patients. In one embodiment, the data and information 82 and 88 including the user's profile and preferences is retrieved from the content database 80 and used to create a unique, user specific presentation of topics 322A and tools and/or functions 324A for the organizational user. For example, the tools and/or functions 324A may include a Resource Center function, an Assessments function, a Progress Reports function and a Rewards, Recognitions and Discounts function customized by the HealthCAWS platform 10 based on characteristics of the organizational user's profile. It should be appreciated that the topics 322A and tools and/or functions 324A presented are not limited, and are dynamically modified as the user's profile and/or platform functionality changes. As shown in FIG. 9A, the presented tools and/or functions include one or more “Go” controls or buttons that invoke additional more specific tools or functions that cascade to a more defined level of detail. For example, selecting the Go button on the Progress Reports function of FIG. 9A invokes an Organizational Alignment Tool—Provider's GUI 330A of FIG. 10A. As shown in FIG. 10A, the Organizational Alignment Tool—Provider's GUI 330A provides access to, for example, a progress report detailing the organization's accomplishments toward reaching certain aims or goals for improving services. It should be appreciated that in accordance with the present invention the cascading to further levels of detailed content is not limited and may be customized for one or more users (e.g., individual patient users, individual organizations and/or individual organization users), and/or individual implementations of the HealthCAWS platform 10 at a healthcare provider and/or healthcare organization level.

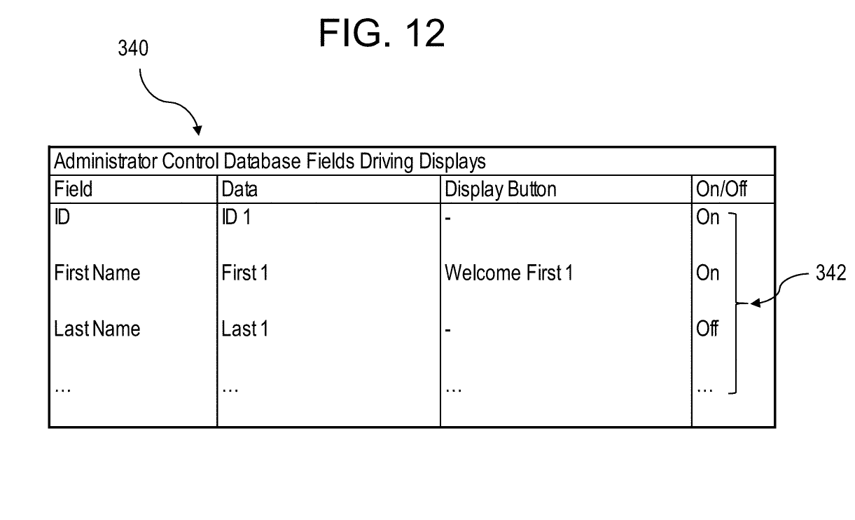

Referring again to FIG. 9, as stated above it is within the scope of the present invention to control (e.g., define) presentation of the user specific presentation of topics 322 and 322A and tools and/or functions 324 and 324A of the Welcome GUIs 320 and 320A, respectively, with the data and information 82 and 88 of the user's profile and preferences retrieved from the content database 80 to create a unique, user specific presentation of topics 322 and 322A and tools and/or functions 324 and 324A. FIG. 12 illustrates one embodiment of fields 340 that allow such control. For example, an On/Off control 342, driven by the individual's or organization's profile, determines whether the information should be presented as a function on the Welcome GUI 320 or one of the more specific GUIs presented by invoking Go button functions.

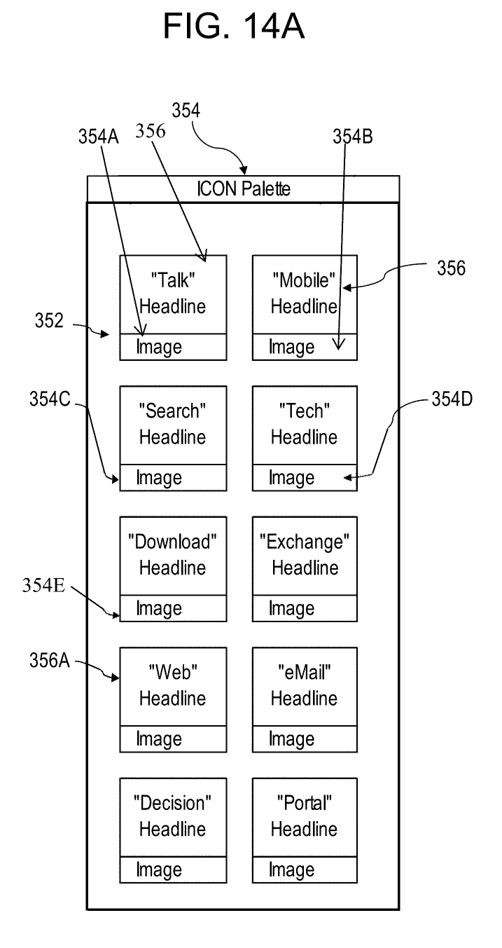

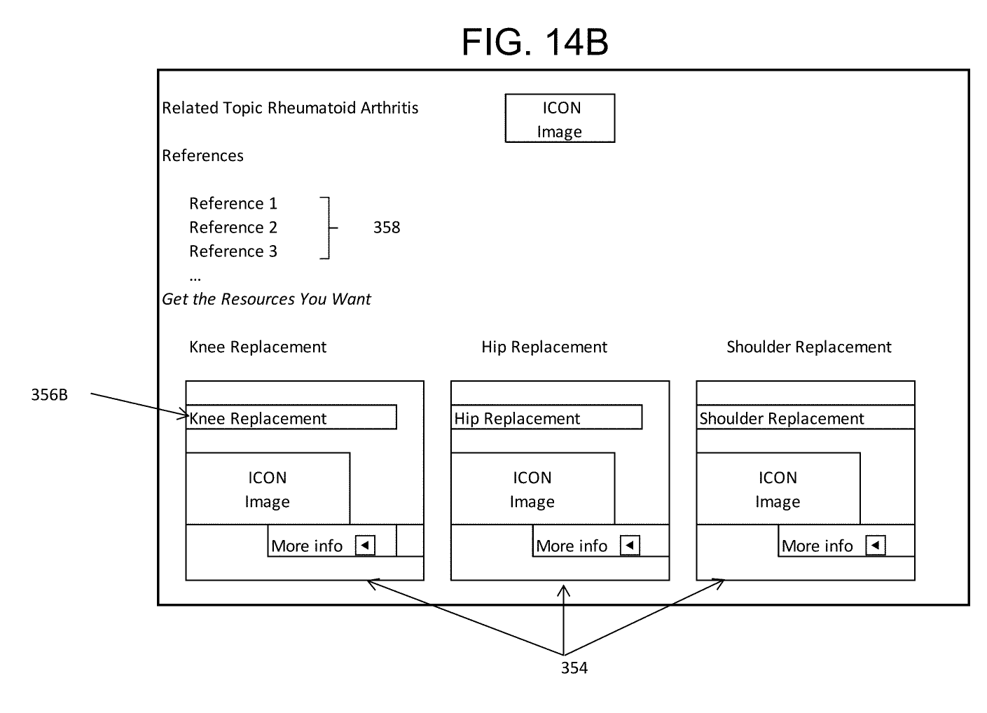

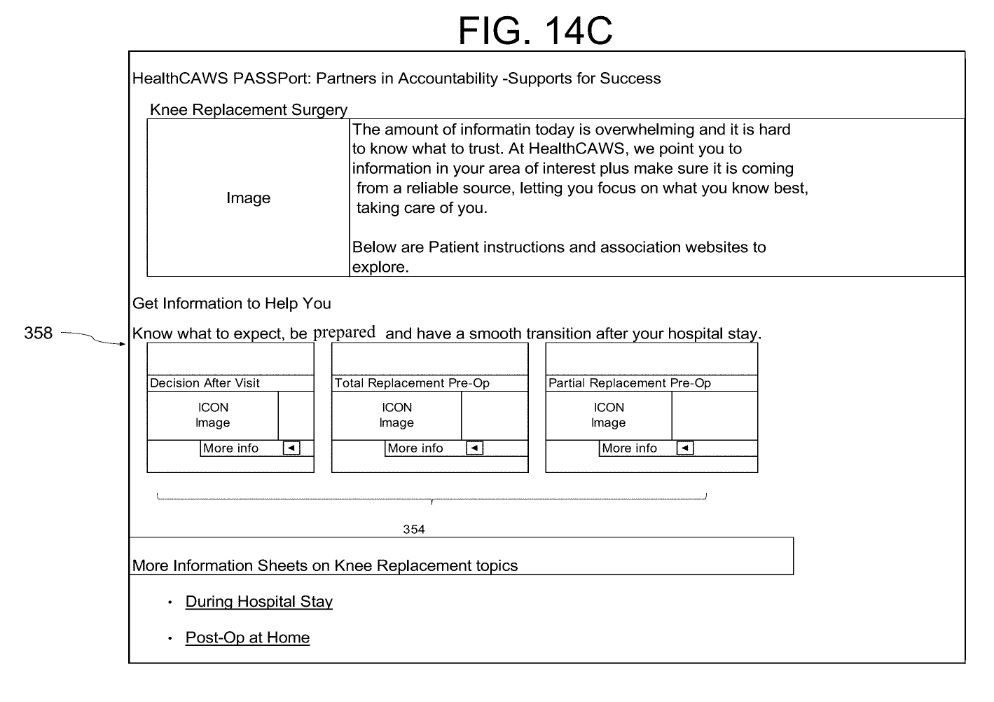

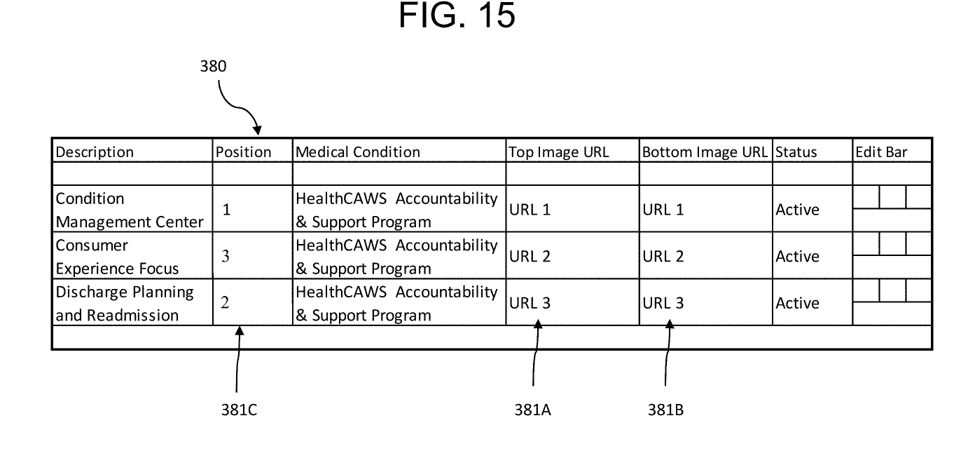

Referring to FIG. 10, in one embodiment, a Go button 332A of the All Key Topics function 332 invokes a Consumer/Provider Resource Center GUI 350 of the HealthCAWS platform 10 (e.g., an embodiment of the Consumer/Provider Resource Center—All Topics page GUI 34), depicted at FIG. 13A. The Consumer/Provider Resource Center GUI 350 provides access to information, tools and functions of general interest, and through corresponding Go buttons or other navigational tools, more detailed information, tools and functions including third party content. Similarly, an Organizational Resource Center GUI 360 of the HealthCAWS platform 10 (e.g., an embodiment of the Organization Resource Center—All Topics page GUI 35) is provided and depicted at FIG. 13B. In one embodiment, the Consumer/Provider Resource Center GUI 350 is provided to individual patient/provider users and the Organizational Resource Center GUI 360 is provided to organizational users. It should be appreciated that the topics, information tools and/or functions presented on the respective Resource Center GUIs 350 and 360 are not limited, and are dynamically modified as the user's, provider's and/or organization's profile and/or platform functionality change. In one embodiment, the adaptability is controlled via backend administrative control tools including custom images, column titles, and topic displayed by activating “go” buttons and the like, which provides customization down to a word level. It should be appreciated that while use and/or activation of “go” buttons is discussed above, it is within the scope of the present invention to employ other navigational tools such as, for example, one or more graphical icons 354 as is shown in FIGS. 14A to 14C, providing access to areas (e.g., chat rooms 354A, Mobile application 354B, a search string 354C, technical note 354D, download screen 354E, and the like, where more information is provided to the user. As shown in FIG. 14A to 14C, the icons 354 are customizable, for example, have a definable title or headline 356, for example, a web page navigational tool 356A is titled based on its content and role in providing more information regarding a knee replacement procedure 356B (compare FIGS. 14A and 14B).

As shown in FIGS. 9 and 9A, the navigational tools may be presented in a menu format such as the go buttons within the tools and/or functions 324 and 324A of the Welcome GUIs 320 and 320A, or as the icons 354 within health related content 358 as depicted in FIGS. 14B and 14C. As can be appreciated the design of adaptable content, including custom images, column titles, and topics displayed and accessed by activating “go” buttons and like navigational tools, e.g., the graphical icons 354, allows for dozens of topics organized in an accessible format amenable to display on any computing or mobile device. Moreover, topics within the resource centers are also dynamically integrated with assessments and progress reports with gaps, recommendations and next steps actions, as described in detail below.

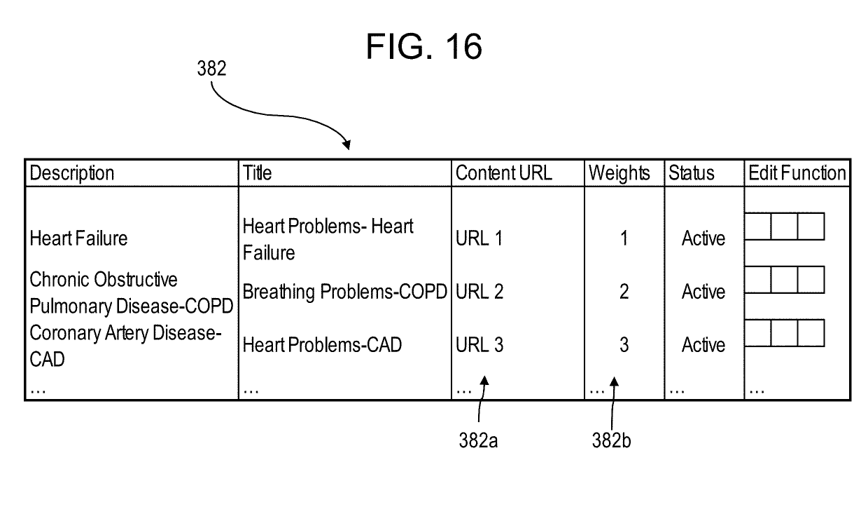

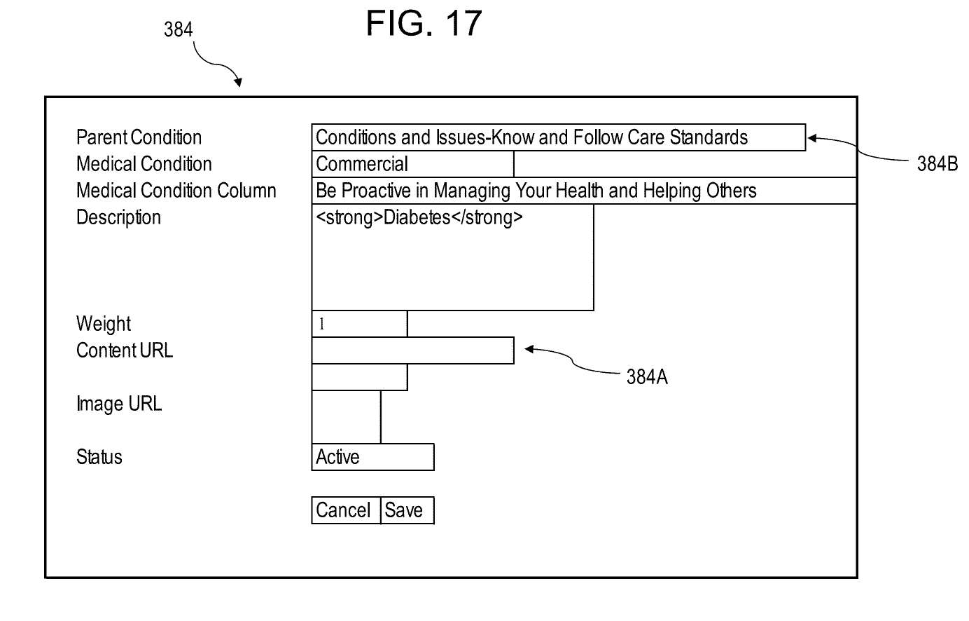

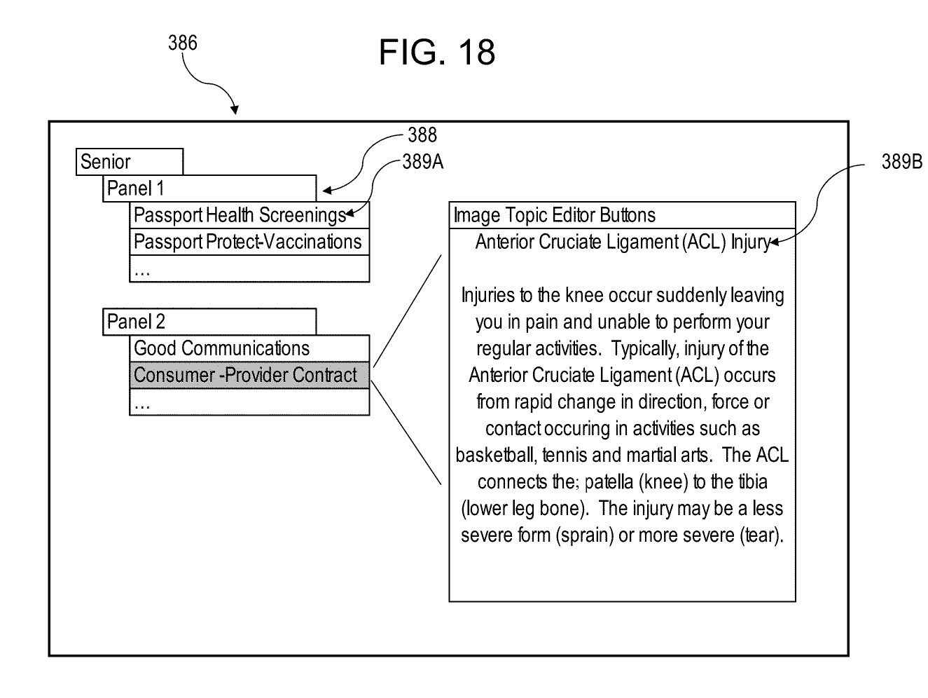

As shown in FIGS. 15, 16, 17 and 18, the topics, information tools and/or functions presented on the respective Resource Center GUIs 350 and 360 including, for example, health and quality/performance improvements topics and text of content are fully customizable by operation of GUIs 380, 382, 384, and 386. For example, as shown in FIG. 15 the Control GUI 380 permits modification, generally at 381A and 381B, of images presented on the Resource Center GUIs 350 and 360, titles or position of display 381C, and the like. As shown in FIGS. 16 and 17, Control GUIs 382 and 384, permit modification of the locations for retrieving content 382A and 384A, weights 382B for position or order within the presentation on the GUIs 30, and bolding or otherwise highlighting of header information or topic bars 384B of the GUIs 30. As shown in FIG. 18, in one embodiment, the user oriented plurality of GUIs 30 are represented as “panels” in a tree structure 388 on the Control GUI 386 and selecting a panel or portion thereof, e.g., an Anterior Cruciate Ligament (ACL) Injury description 389A, invokes a text editor tool that permits modification of the text (e.g., word by word editing) of the content 389B within the Anterior Cruciate Ligament (ACL) Injury description 389A. In one embodiment, content may be located within the HealthCAWS platform 10 or within a source that is linked to and accessible by the platform 10 by means of, for example, content URLs. In one embodiment, a tool or crawler executes periodically, for example, nightly, and detects whether one or more of the content URLs is inactive or otherwise inaccessible. Any problems uncovered by the tool or crawler may be output or otherwise reported to the administrator for repair of replacement of the content URL link.

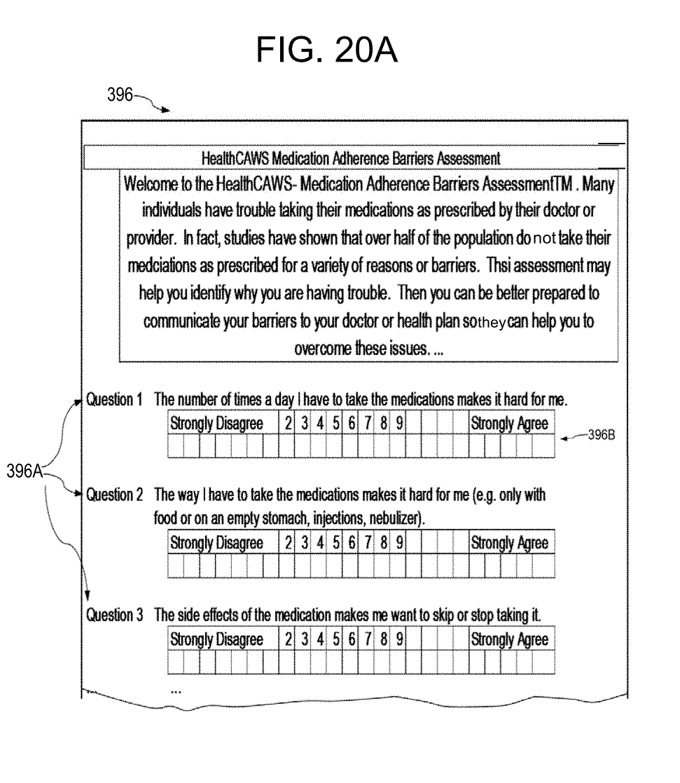

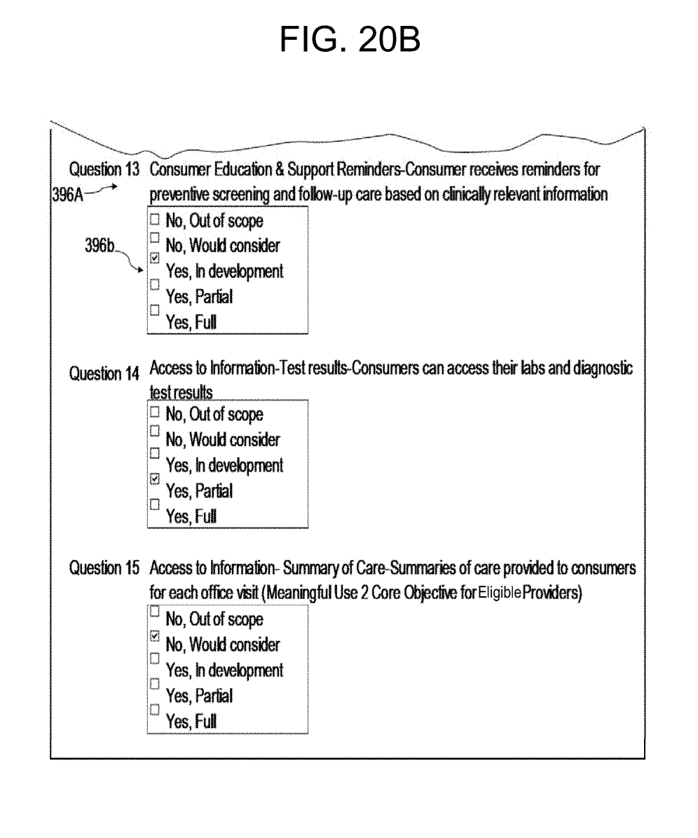

Referring again to FIG. 9, selecting the Go button 326A of the My Assessments function 326 invokes a more specific My Assessments GUI 390 of FIG. 19. In one embodiment the My Assessments GUI 390 includes a list or history of links 392 to previous assessments or surveys taken as well as one or more links 394 to new assessments or surveys that are available to be taken by the user. FIG. 20 illustrates one embodiment of an Assessment GUI 396 utilized in the HealthCAWS platform 10. As shown in FIG. 20, the Assessment GUI 396 may include a series of questions 396A and optional responses 396B from which an answer may be chosen. The backend administrative controls allow for instantaneous customization of displays driven by adaptation of any assessment, response scale, scoring weighting, and recommendation and next steps messaging and links down to the word level.

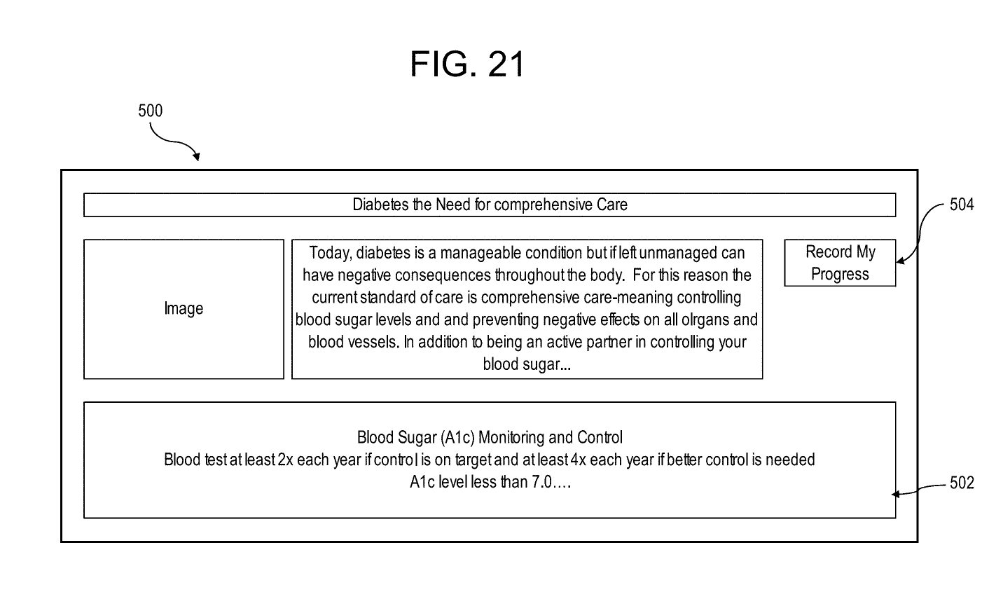

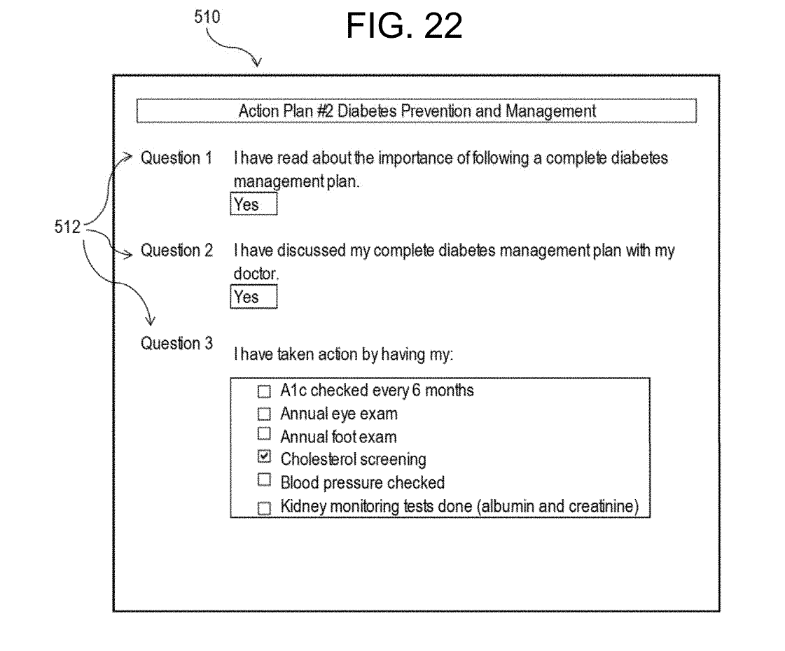

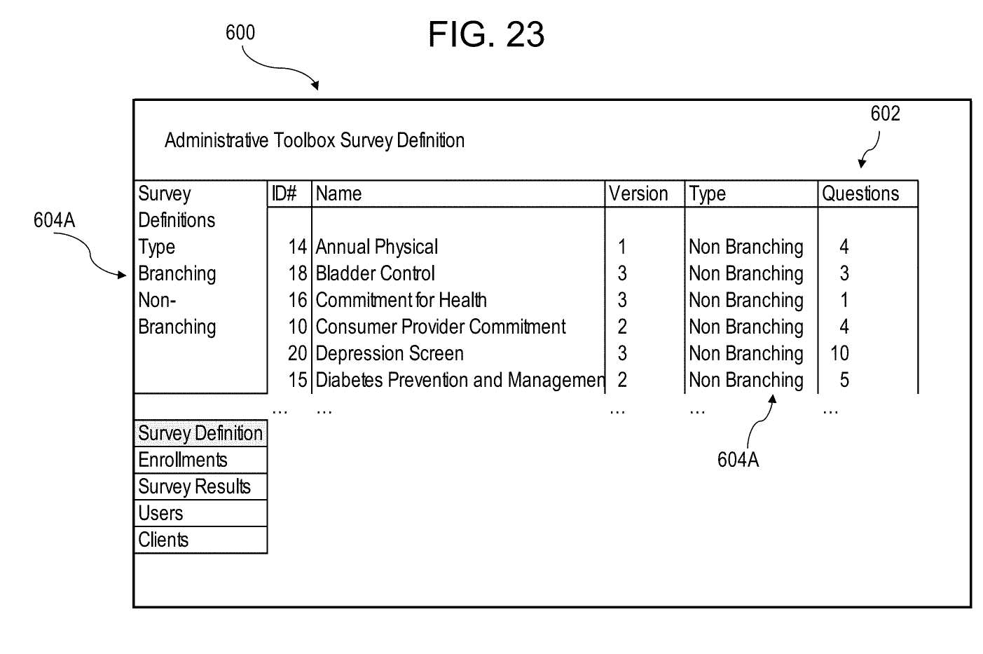

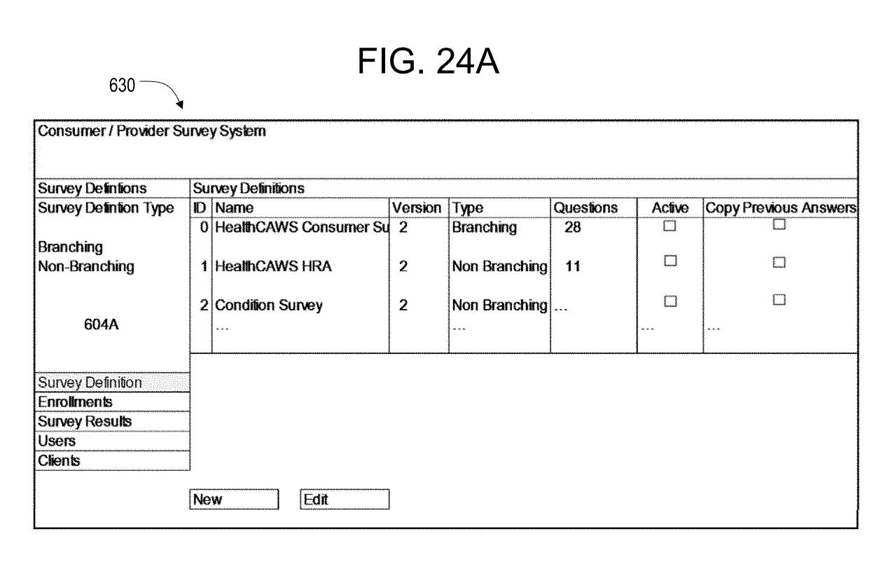

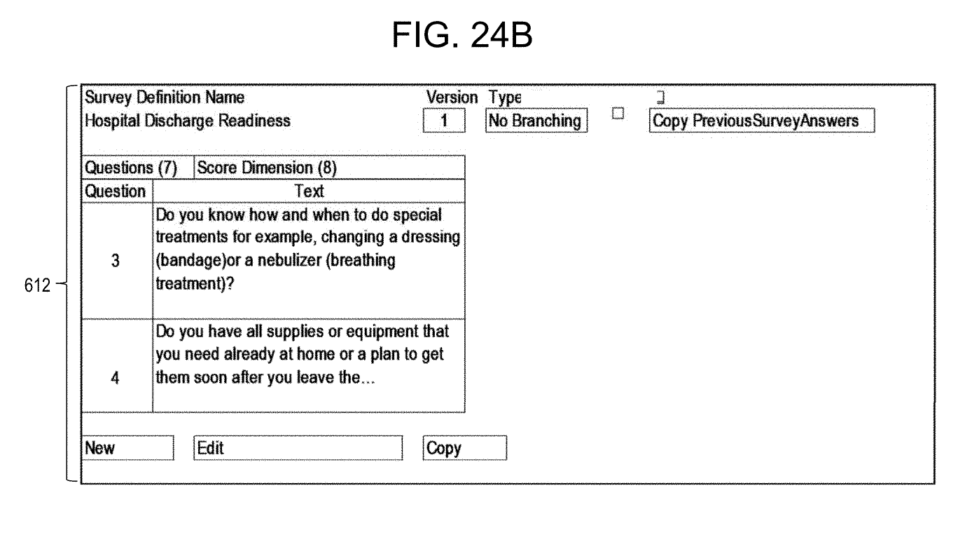

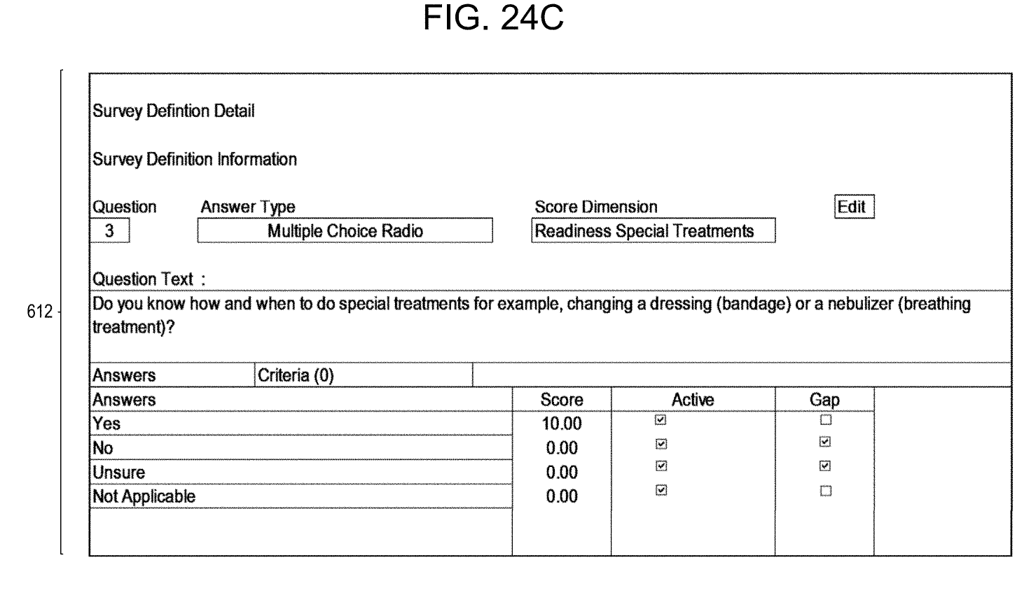

In one embodiment, assessments and/or actions plans may be embedded within health related content including one or more of the GUIs 30. For example, as illustrated in FIGS. 21 and 22, portions of an assessment and action plan are embedded within Diabetes Health Topic GUIs 500 and 510 such that a user may record his/her progress and/or actions taken, as shown generally at 502 and 512, respectively. It should be appreciated that in one embodiment the imbedding may be automatic or predetermined based on, for example, characteristics of the user's profile, or in an other embodiment, the imbedding may be invoked by the user, for example, by activation of a Record My Progress control 504 as shown in FIG. 21. As shown in FIGS. 23 and 24, in one embodiment Administrative Control GUIs 600 and 610 permit definition/creation of new and/or modification of existing, shown generally at 602 and 612, question content, response scale (e.g., “yes”/“no”, “strongly disagree” to “strongly agree”, or the like), scores (e.g., 0 to 10, 0 to 25, 0 to 100, or the like), whether an answer to a question is mandatory or permissive, when the question and/or answer should be included in reports (e.g., providing an ability to keep information confidential), whether previous answers should be displayed to provide visibility to past assessments when the user returns to review the content again, and the like. In one embodiment, questions may be nested or branched 604A and 604B such that related, more detailed questions may be posed when a user indicates a particular answer. In one embodiment, the customizations are stored in the preference data and information 88 in the content data base 80.

In one embodiment, the Administrative Control GUIs 600 and 610 of FIGS. 23 and 24 allow each assessment and/or action plan to be loaded/presented and customized to characteristics of a user's profile, without re-programming or re-coding GUIs 30 to include, for example:

1) Specific text, ordering of text or other items presented on the GUIs 30, and/or to include branching logic between and among related questions or topics;

2) Assignment of each item to a scoring dimension and/or sub-dimension, for example, in a health risk assessment an item asking about number of servings of fruits or vegetables per day may be assigned to a dimension “lifestyles” and the sub-dimension “weight management.” The ability to see various levels of granularity in reporting is important for individual and organization level prioritization for improvement efforts;

3) Response type (e.g., multiple choice, rating scale, etc.) with response choice wording and whether or not that response on the rating scale represents a gap or opportunity for improvement;

4) Assignment of scores for each response choice on each rating scale;

5) Unique messaging back to the user based on their responses falling into a score range set by the controls, for example, when considering an organization's outcome evaluation plan if they are scoring in the lowest range, the message and link support them to introductory resources (e.g., GUI 350) to begin defining their plan, while those scoring in the higher range receive messages/links (e.g., GUI 360) related to submitting their data for quality bonuses, where eligible;

6) “Next step” actions embedded in the messaging to include the capability to take users to another web location offered by the client or back to another HealthCAWS tool or content, or display of any message set by the controls such as, for example, “Please call care manager Ms. Susan Smith at 1-800.123.4567”, or the like;

7) Display previous answers or not depending on whether an updatable assessment or action plan is desired or a new assessment is desired to be displayed each time. In one embodiment, in both cases a date stamp is displayed under user assessment history; and

8) Unique title, branding, welcome and instructions set by administrator control.

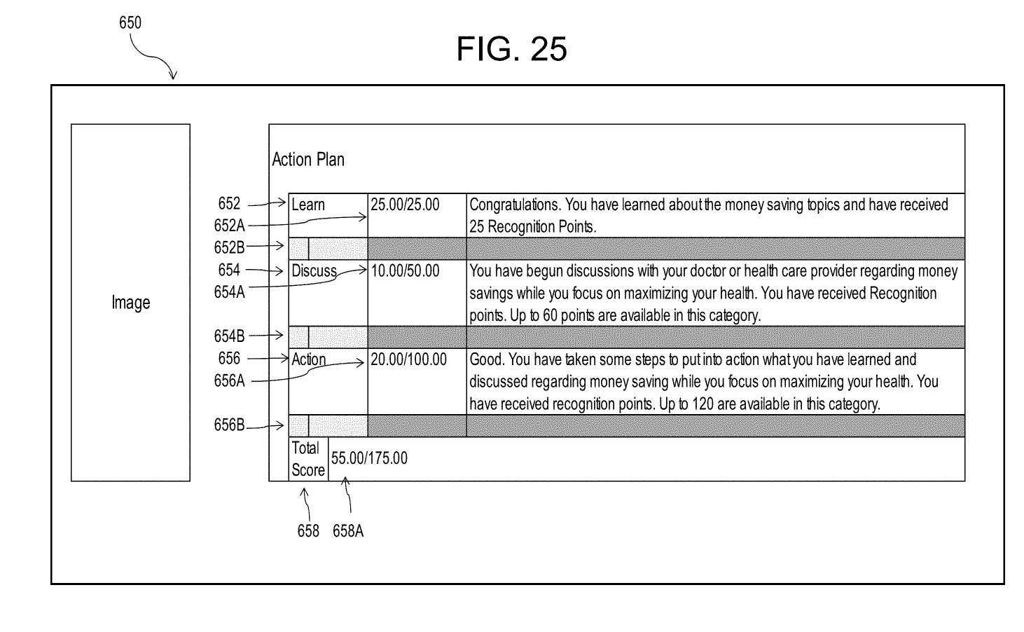

In one embodiment, the HealthCAWS platform 10 and the administrative tool box 90 include a Progress Reports tool and/or feature that process the assessment data and information 84 and/or the accumulations data and information 86 and provides real-time progress reports to present to users. In one embodiment, the progress reports may include detailed summary reports generated in a system format or in a user defined format, and in another embodiment, the progress reports may include notification messages such as, for example electronic mail messages, text messages and the like directed to one or more specific users and/or predefined recipients (e.g., at their client devices 50, 52 and 54). In one embodiment, illustrated in FIG. 25 an exemplary Summary Progress Report GUI 650 is depicted. As shown in FIG. 25, the Summary Progress Report GUI 650 may include categories that highlight areas of learning 652, recommendations or areas of encouragement for discussions and the like 654, and recognitions of completion of actions taken 656, and the like. In one embodiment, the Summary Progress Report GUI 650 presents scores that track user progress, for example, numerically at 652A, 654A, 656A and 658A, and graphically such as on a bar chart or the like, at 652B, 654B, and 656B, for each of the aforementioned categories of learning 652, recommendations 654, and actions 656, as well as a total across these categories 658. In one embodiment, the Progress Reports tool of the HealthCAWS platform 10 includes an ability to match or pair a survey (e.g., by a unique Survey ID or identification code) to an individual user (e.g., by a unique user ID or identification code) within a single content URL string. In this manner, the Progress Reports tool provides customized progress report results.

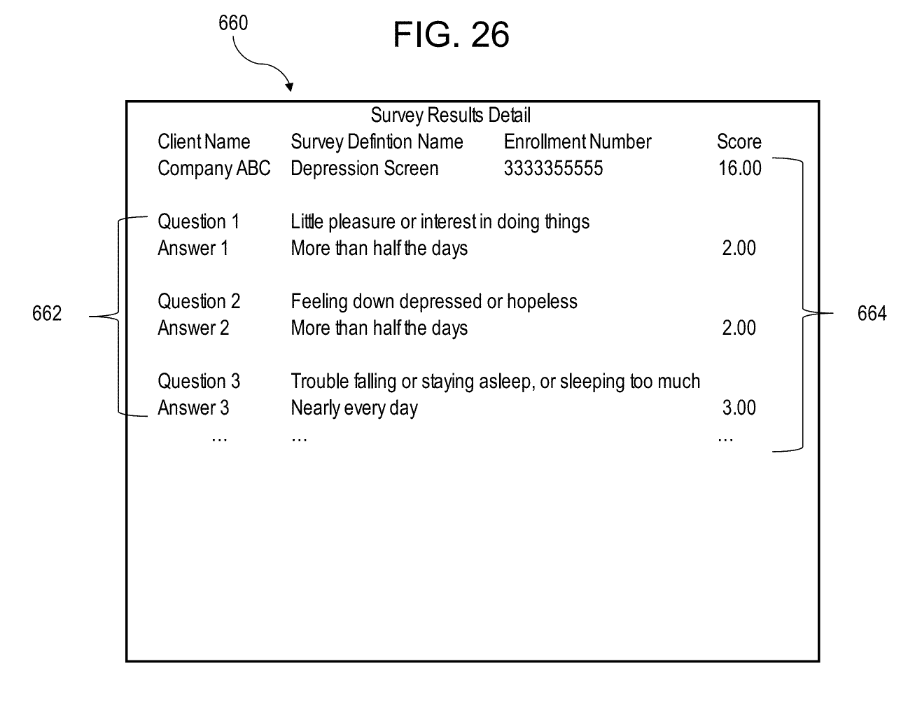

In addition to providing the Summary Progress Report feature in, for example, real-time to users, the Progress Reports tool also provides access reports in the summary view or in an item-by-item Survey Results Detail GUI 660 as shown in FIG. 26. For example, in the item-by-item Survey Results Detail GUI 660 specific questions and answers are presented, generally at 662, with corresponding scores, generally at 664. As shown in FIG. 9, the Go button 327A on the My Progress Reports function 327 of the Welcome GUI 320 may be used to invoke the item-by-item Survey Results Detail GUI 660. In one embodiment, described in more detail below, the HealthCAWS platform 10 may include access and/or links to a Reward and Discount program that encourages and rewards user participation in various aspects of healthcare and decision making surrounding the same. In this embodiment, the scoring and/or points available and points earned (e.g., the scores 652A, 654A, 656A, 658A, and 664) within the HealthCAWS platform 10 correspond to the branding and/or methodology employed by the specific Reward and Discount program, and the brand's and/or methodology's labels and other narratives may be incorporated in custom messages within the HealthCAWS platform 10.

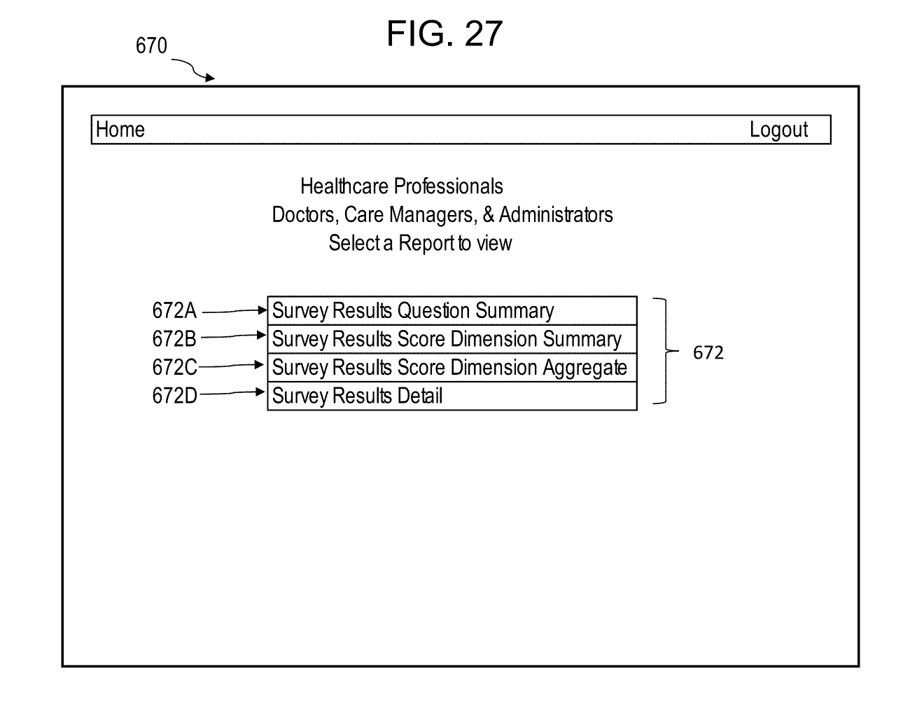

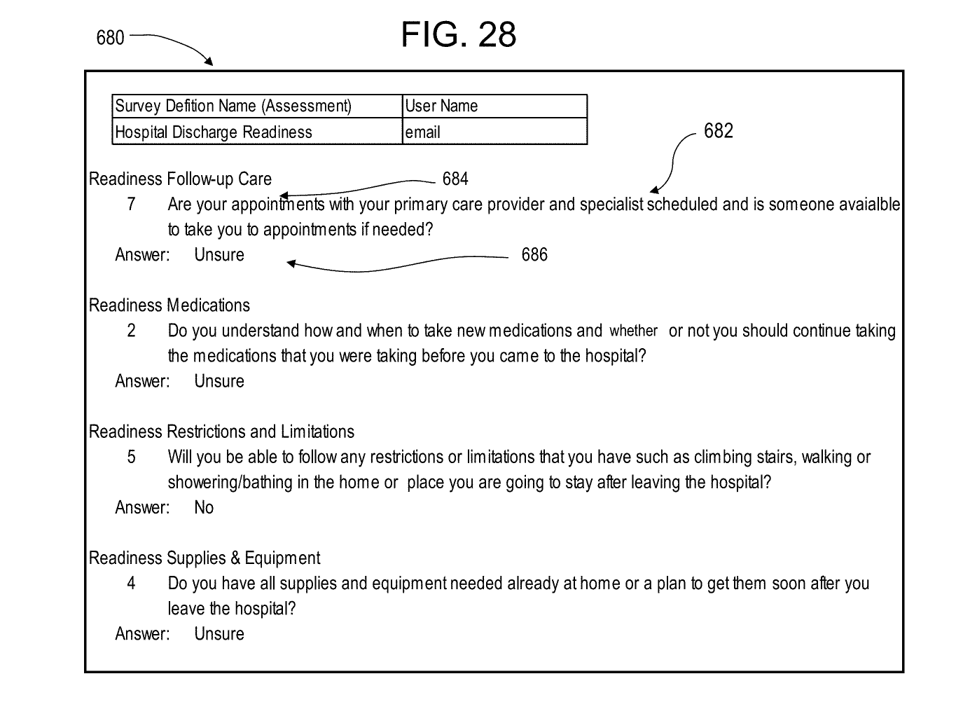

In one embodiment, illustrated in FIG. 27 the HealthCAWS platform 10 includes a Healthcare Professionals Report Generator GUI 670 that provides access to one or more reports 672. In one embodiment, the reports 672 may be auto-generated, e.g., preformatted, such that programming is not needed to extract and review details of the reports 672. As shown in FIG. 27, one or more of the reports 672 may be invoked by selection of a corresponding control 672A, 672B, 672C and 672D. In one embodiment, illustrated in FIG. 28, the HealthCAWS platform 10 includes an Improvement Opportunities Gap Detail Report GUI 680, which may be invoked from the Healthcare Professionals Report Generator GUI 670. As shown in FIG. 28, the Improvement Opportunities Gap Detail Report GUI 680 provides visibility to one or more areas 682 within assessments, surveys, questionnaires, or other input from users (e.g., patients, care providers or others) that provides non-specific feedback such as, for example, an answer of “unsure” 686 or the like, on one or more surveys or questionnaires 684. It should be appreciated that this opportunity or gap reporting, may identify specific items (e.g., the areas 682) within the one or more surveys or questionnaires, as well as may highlight general trends (e.g., positive or negative) in care from the accumulation data and information 86. By reviewing the Improvement Opportunities Gap Detail Report GUI 680, care providers, managers, administrators or other authorized users can address what may be perceived deficiencies, inadequacies and/or other areas for improvement in care or the like, to better improve quality, efficiency or other areas of actual or perceived problems in the delivery of healthcare services and/or resources in specific and/or general areas of care.

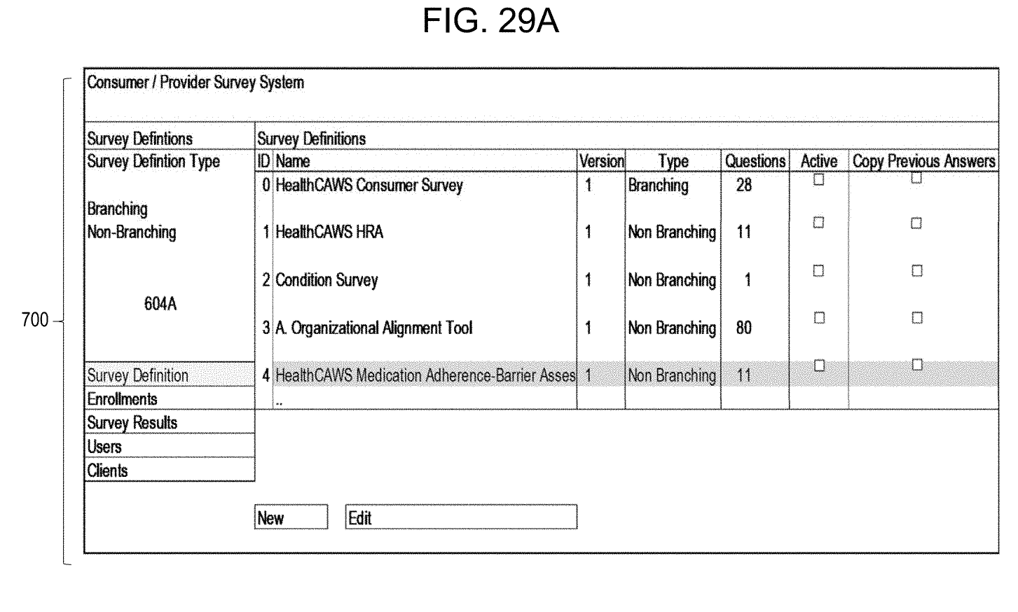

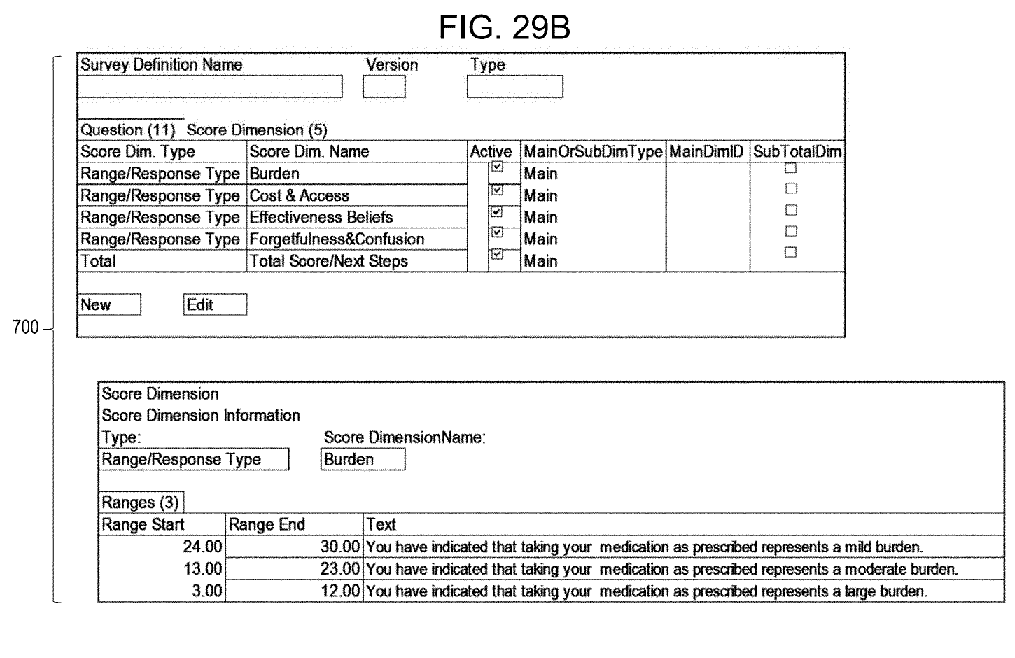

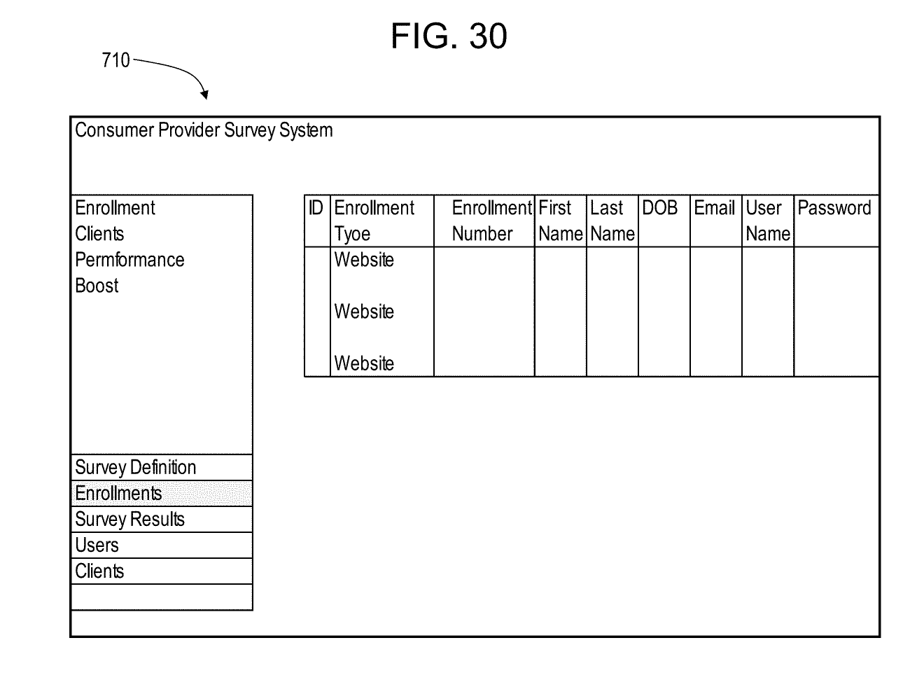

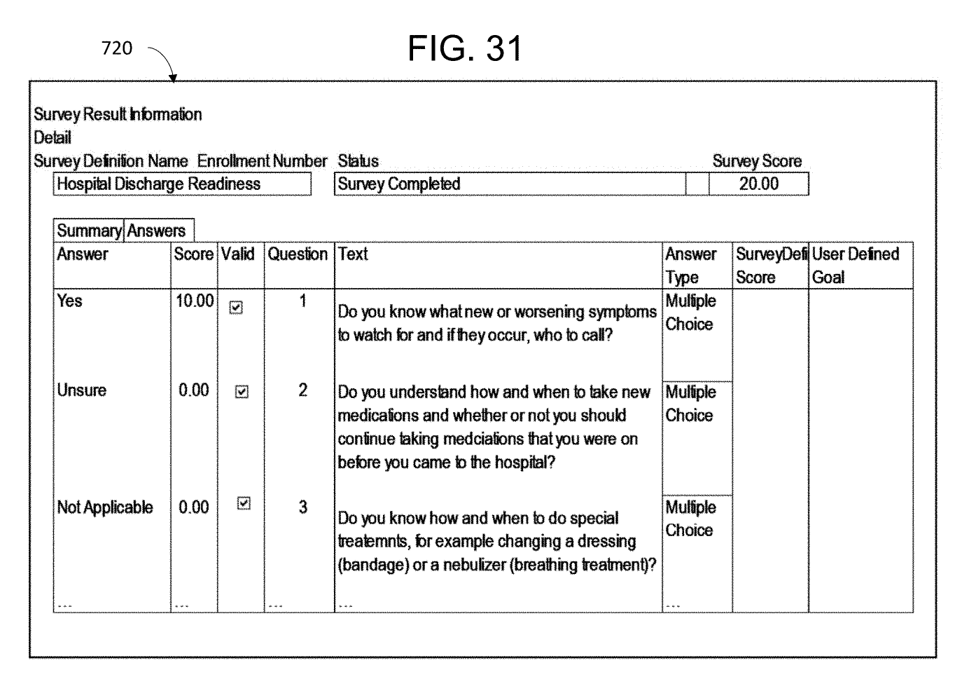

As shown in FIG. 29 an Administrative Control GUI 700 permits definition and/or modification, shown generally at 702, of the reports including selection of question content, response scale, scores, and report messaging and comments that are extracted from one or more surveys or questionnaires 684 and/or generated to provide feedback to the care providers, managers, administrators or others that are working to address the perceived deficiencies, inadequacies and/or other areas for improvement in care or the like, identified by the reporting. As shown in FIGS. 30 and 31, Administrative Control GUIs 710 and 720, allow care providers, managers, administrators or other authorized users to view enrollment, results, scores and questions of the one or more surveys, questionnaires or assessments, in the aggregate (across a plurality or population of users), for individual users, and/or at a session level. In one embodiment, this data may be exported out of the HealthCAWS platform 10 in formats compatible with commonly used software applications such as, for example, Excel™, Word™ or the like of Microsoft Corporation or other software providers, for analytical or integration purposes. As such, the Administrative Control GUIs 700, 710 and 720 provide for robust reporting features that support a continuous commitment to quality improvement.

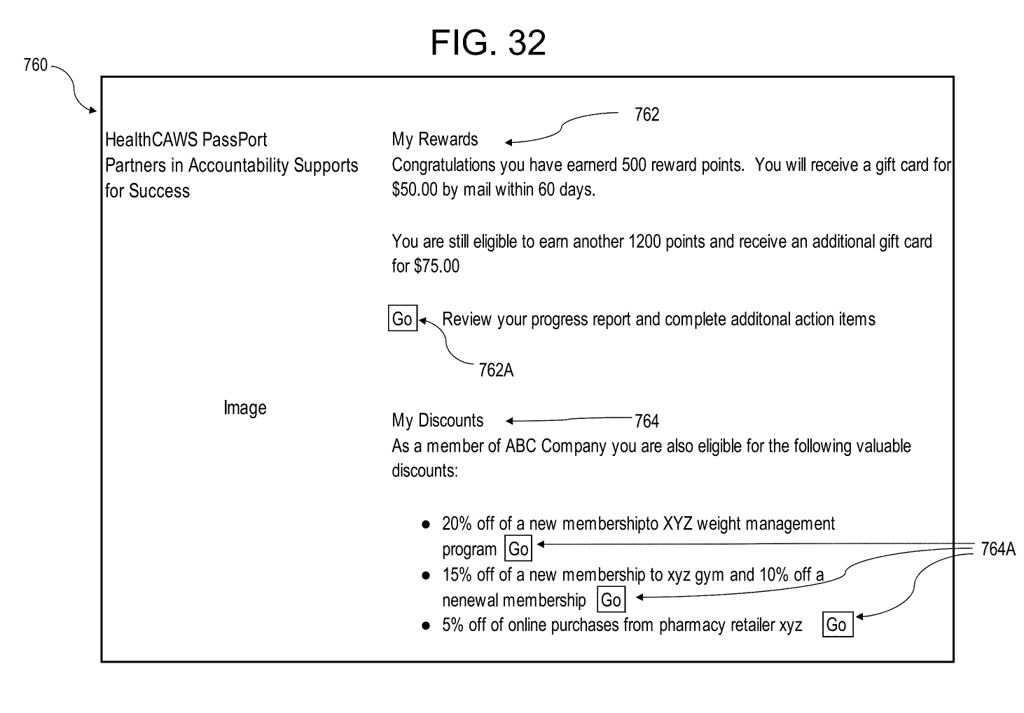

As shown in FIG. 9, the Go button 328A on the My Rewards and Discounts function 328 of the Welcome GUI 320 may be used to invoke a My Rewards and Discounts GUI 760 of FIG. 32. In one embodiment, the My Rewards and Discounts GUI 760 provides access and/or links to one or more Rewards 762 and/or Discounts 764 that encourage and reward user participation in various aspects of healthcare and decision making surrounding the same, such as, for example, discounts for weight management programs, fitness facilities, at pharmacy, and the like, shown generally at 764A. Additionally, a user may track points earned towards such rewards and discounts, as shown generally at 762A.

Referring again to FIG. 1, it is within the scope of the present invention to link the web site 28 of the HealthCAWS platform 10 to one or more third party web sites 110, for example, web site 1 to web site N, to provide access to, for example, social media/networking tools and features, blogs, community message boards and the like, for one or more of the GUIs 30. In one embodiment, the Welcome or home page GUI 32 (e.g., the Welcome GUI 320 of FIG. 9) includes a link, via a Go button 329A of a My Community function 329 of the Welcome GUI 320, to for example, a Health related website or a healthcare facility's page on Facebook™ or like social media network. In one embodiment, the administrative tool box 90 provides contact and interaction with such third party web sites 110 while also allowing for setting and limiting various levels of access to content on the HealthCAWS platform 10 to authorized users.

It should be appreciated that the HealthCAWS platform 10 may be integrated within a client web site or portal, and may be the integrator of other client functions. Additionally, while specific tools and/or features have been described above, there is no limit to the number or type of “Go” button functionality that may be displayed on the Welcome GUI 320 or other GUIs 30 in the platform 10. As such, traditional health plan or delivery system administrative functions including, but not limited to, billing and payment functions, access to explanation of benefits, benefit cards, refilling a prescription, and making appointments can be linked seamlessly and supported by the HealthCAWS platform 10 and adaptable administrator controls. This capability provides significant convenience for the end user and cost efficiency to the client.

As described herein, the HealthCAWS platform 10 provides integrated features and functionality driven, in substantial part, by intricate administrator controls available in the GUIs 40 that allow for substantial adaptability of features, functions and presentation of healthcare data and information on the GUIs 30, without costly and barrier-ridden re-programming time. Accordingly, the HealthCAWS platform 10 assists consumers, providers and organizations to meet the demands of an accountability environment while providing the necessary information and tools support in a convenient actionable format. A summary of some features of the HealthCAWS platform 10 include:
Highly adaptable and interoperable a platform that affords customization for consumer, provider, and organizational end users with real-time interactive displays driven from the administrator controls without additional coding/programming;
Spans full continuum of health and healthcare quality and cost issues;
Integrates a convenient electronic (web and mobile) user interface with a database infrastructure to create an individualized, interactive, action oriented experience;
Provides convenient access to all data driven content and tools from easy to use “Go” buttons on the Welcome Panel display driven by the administrator controls;
Health content seamlessly cascades through easy to use controls, icons and/or buttons to meet individual level and scope of interest and need;
Drives Action with Assessments, Action Plans and Reward Programs through real-time feedback and next steps links embedded in individualized progress reports customized from the administrator controls;
Includes an administrative and professional login with automated individual detailed reports and aggregate reports on an administrators/providers total population; and
Includes an integrated custom built backend Content Management System, and Assessment and Reporting Application that allows for customizing all content and tools down to the word level from the administrator controls without additional programming to efficiently meet client needs.

In one embodiment, the HealthCAWS platform 10 is implemented as a cloud-based, interoperable software as service (SaaS) solution to health care payers and provides delivery systems designed to align accountability models and managed consumerism. Due to the cloud-based nature of the solutions, no installation need be performed on client server computers as system server computers host the features and functions of the platform 10. Updates are also distributed, for example, in real-time, so there is no version control and management issues for clients. All solutions are built for customization and integration with other client solutions for cost efficient and effect impact on health care quality and affordability.

In one embodiment, content within the HealthCAWS platform 10 is managed in relational database, e.g., the content data base 80, and organized by, for example, topic name, date reviewed, date scheduled and date published. For content that is to be published at intervals other than at initiation of the client instance (e.g., at implementation at a client site), the platform 10 query rules prompt publication on predetermined, scheduled dates. In one embodiment, the platform 10 is designed so that revised content is loaded and republished based on review date.

In one embodiment, security within the HealthCAWS platform 10 includes, as all client implementation instances, a security certificate employed within a “https” site. The HealthCAWS platform 10 supports industry standards for secure data exchange and protection of personal health information (e.g., is HIPAA compliant). In a SaaS, cloud-based implementation the features and functions of the HealthCAWS platform 10 are hosted by reputable hosting service with extensive data security, redundancy systems, disaster recovery plans and strict facility access limits.

In one embodiment, validation and content editing includes content and metadata validation built into the HealthCAWS platform 10. In one embodiment, scalability is obtained by employing a cloud-based, SaaS model for the HealthCAWS Platform 10. A reputable hosting service offers a state-of-the-art network and datacenter located within secure and reliable facilities, offering the utmost in service, speed, and network availability. Service includes the latest technology and equipment, advanced levels of security, and a 24/7 team of on-site dedicated professionals. In one embodiment, the technology infrastructure of the HealthCAWS platform 10 includes, for example, a database engine created using Microsoft SQL, or other proven, reliable data management and reporting platforms developed to enable highly intelligent and scalable business solutions. Service level performance includes uptimes in excess of ninety-nine and one half percent (99.5%). Uptimes are consistently achieved due to power, 24/7 on site staff and multiple redundancies. Page load times per page for the HealthCAWS platform 10 is preferably nearly always less than one second, and in many instances as low as 0.10 of a second (or 100 milliseconds).

In one embodiment, the HealthCAWS platform 10 utilizes maintenance schedules and staging from development to production established for a disruption free user environment. Should scheduled maintenance require disruption, notification is made one week in advance, occurs for no more than two (2) hours and is done between the hours of midnight and five am central standard time. Any notifications regarding disruption originating from the web hosting service is provided to the client.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the appended claims.

What is claimed is:

1. An interactive healthcare accountability and support system, comprising:
a server computer having a server processor and a server memory storing a plurality of instructions executable by the server processor;
a plurality of client devices operatively coupled to the server computer over a communication connection, each client device having a client processor, an input-output controller and input-output devices for inputting and for viewing algorithmically compiled and transformed health related data and information; and
a content database operatively coupled to the server computer, the content database receiving and storing the health related data and information;
the server processor configured to provide:
a first plurality of graphical user interfaces (GUIs) accessible by a plurality of stakeholders, the plurality of stakeholders including at least one patient operating one of the client devices, the first plurality of GUIs being selectively customizable by a set of parameters to collect, analyze and dynamically display at least one action plan for the patient based on health related data and information input by the patient, the first plurality of GUIs including a first GUI having a first field;
an administrative tool box configured to establish controls for the set of parameters within at least one algorithm, the set of parameters including (i) an item or question, (ii) a response choice, (iii) a score for the response choice, (iv) a dimension assignment, (v) a sub-dimension assignment, (vi) a cluster assignment, (vii) a gap assignment to the response choice, (viii) one or more of computed and compiled score strata or score ranges, (ix) a unique message assigned to a combination of one or more of the set of parameters, and (x) an instruction to execute algorithmic calculations and transformations in real-time including from a plurality of possible combinations derived from one or more of the set of parameters thereby dynamically displaying numerical, graphical or text images on at least one of the first plurality of GUIs based thereon; and
a second plurality of GUIs accessible by at least one other user that is different than the at least one patient, the second plurality of GUIs including a second GUI having a second field similar to the first field on the first GUI, the second plurality of GUIs including support tools and functions invoked by the administrative toolbox and configured to dynamically customize the first plurality of GUIs in real time, without modification to the instructions within the server memory, by auto generating new displays on the customizable first plurality of GUIs in real-time based on the algorithmic calculations and transformations derived from the one or more of the set of parameters, the new displays auto generated in real time on at least the first GUI based on a modification of the second GUI by the at least one other user;
wherein the administrative toolbox is further configured to provide the support tools and functions of the second plurality of GUIs to:
dynamically manage a plurality of the one or more of the set of parameters including the response choices, and assignment of scores, dimensions, sub-dimensions and gaps for each action plan; and
automatically and in real time control a presentation of the first field on the first GUI and control in real time the one or more of the set of parameters to change the response choices and assignments of scores, dimensions, sub-dimensions and gaps for each action plan, based on the at least one other user modifying the second field on the second GUI, and thereby dynamically manage the algorithmically transformed health related data and information based on an individual profile of the patient for engaging the patient in real-time.

2. The interactive healthcare accountability and support system of claim 1, wherein the use of the support tools and functions renders at least one display item actionable by the patient to provide patient accountability and support including generating an auto calculated and algorithmically derived next step action to be taken by the patient.

3. The interactive healthcare accountability and support system of claim 1:
wherein the health related data and information includes patient generated data and information including a patient's assessment data and information including assessments gauging a patient's progress along a predetermined or user-defined action plan based on tracked actions taken by the patient, and patient reports of progress toward a relatively more healthy state or condition or progress on their own user-defined goals in the action plan, and accumulations of the algorithmically transformed data and information from a grouping of action plans or assessments, wherein information relating to the assessments and the patient reports is displayed in the first plurality of GUIs and is displayed in at least one third GUI, and the at least one third GUI is a professional portal accessible by a healthcare professional; and
wherein the administrative tool box is further configured to generate further auto calculated and algorithmically derived health related data and information in real-time, including values and parameters that are used by the administrative toolbox to customize the first plurality of GUIs, to populate the professional portal and provide access to the healthcare professional operating the professional portal in one of the client devices to view the patient's progress on the action plan and/or the assessments and to support the patient's management and accountability efforts to improve the patient's health and the patient's cost of health care, wherein modification of the one or more of the set of parameters via the second plurality of GUIs automatically and in real time updates both the first plurality of GUIs and the at least one third GUI.

4. The interactive healthcare accountability and support system of claim 3, wherein the administrative tool box is further configured to:
dynamically create in real-time new patient actions plans and assessments based on input from the at least one other stakeholder;
auto assign a transmittable patient identification code;
auto link to create real-time external html displays for action to be taken by the patient;
auto link to external databases and to one or more third party web sites;
generate a reporting package including descriptive statistics generated from data further algorithmically cumulated and calculated simultaneously with the singular operation of creating a new action plan or assessment; and
report examples include item summary, dimension summary, gap summary, dimension aggregate and reward and recognition aggregate.

5. The interactive healthcare accountability and support system of claim 1, wherein the administrative toolbox is further configured to:
dynamically modify specific text, ordering of text or other items presented on the first plurality of GUIs to identify connections between and among related questions or topics;
assign at least one of a scoring dimension and a sub-dimension to items within assessments of a stakeholder's health or organization's status;
assign a response type with response choice wording and whether or not that response on the rating scale represents a gap or opportunity for improvement;
assign scores for each response choice on each rating scale based on a next step action generated by the patient or at least one other of the plurality of stakeholders operating one of the client devices;
provide unique messaging to the patient based on the patient's responses falling into a predetermined score range;
define next step actions embedded in messaging stratified by dimension and sub dimension to guide the patient's actions toward improved health and lower cost outcomes; and
selectively present or inhibit presentation of previous answers on an assessment through administrative tool box controls and selectively allow answers to be updated resulting in a recalculation based on the algorithms resulting in a new progress report and next step messaging presented to the patient in real-time.

6. The interactive healthcare accountability and support system of claim 1, wherein the administrative toolbox is further configured to:
dynamically modify an interrelationship between items of content within a tree structure through parameter assignment, computation and display.

7. The interactive healthcare accountability and support system of claim 1, wherein the new displays include an updated or new action plan for the patient, the updated or new action plan based upon the health related data and information input by the patient and the algorithmic calculations and transformations.

8. The interactive healthcare accountability and support system of claim 1, wherein the at least one action plan is based upon recommendations for persons with health statuses or behaviors similar to a health status or behavior of the patient.
